(19) United States
(12) Patent Application Publication
(10) Pub. No.: US 2006/0238160 A1
(43) Pub. Date: Oct. 26, 2006

(54) Drive apparatus

(76) Inventors: Shingo Fukamizu, Takatsuki-shi (JP); Yasunori Yamamoto, Hirakata-shi (JP)

Correspondence Address: RATNERPRESTIA, P.O. BOX 980, VALLEY FORGE, PA, 19482, US

(21) Appl. No.: 11/398,399

(22) Filed: Apr. 5, 2006

(30) Foreign Application Priority Data
Apr. 12, 2005 (JP) 2005-114880

(51) Int. Cl. G05B 1/06

(52) U.S. Cl. 318/652

(57) ABSTRACT

Optical disc drives designed for reduced power consumption switch the supply voltage in three stages between first, second, and third power supplies, but the reduction in power consumption that is possible in the drive circuits with three stage switching control is limited. A drive output tracking signal is generated according to the waveform of the drive output that drives the focus and tracking actuators, and this drive output tracking signal is applied to a step-up type focusing and tracking power supply. The step-up power supply controls the fixed output according to the drive output tracking signal, and when the drive output is greater than the fixed output, control output that is greater than or equal to the fixed output and slightly greater than the drive output is generated. This control output is supplied to the focus and tracking drive circuits to produce drive output.

### BACKGROUND OF THE INVENTION

1. Field of Technology

The present invention relates to a drive apparatus for use in devices such as optical disc recording and playback drives, and relates more particularly to technology for reducing power consumption by the drive circuit while increasing the drive speed by improving the drive performance of the drive circuit.

2. Description of Related Art

Optical disc media offer numerous benefits, including long media life as a result of non-contact recording and reading, random accessibility enabling significantly faster access to desired content than is possible with magnetic tape, and a large storage capacity. Disc drives for reading and/or writing Compact Disc (CD) and DVD (digital versatile disc) media have thus become standard equipment on most personal computers sold today. In order to meet the demand for ever higher data transfer rates, faster disc motors are being used to rotationally drive the optical discs.

Optical disc drives used in desktop personal computers generally have a 5-V power supply with an output voltage of 5 volts, or a 12-V power supply with an output voltage of 12 volts. In the case of drives that are built in to notebook computers or used as external peripherals to desktop computers, a 5-V power supply with an output voltage of 5 V is generally used. Conventional technology used in a low voltage power supply such as used primarily in notebook computers is described below.

Two types of actuators are used in optical disc drives in order to track the laser spot formed by the optical pickup. One of these is a focusing actuator for adjusting the focus by moving the objective lens of the optical pickup in the focusing direction. The other is a tracking actuator for tracking the recording path by moving the objective lens in the tracking direction. The 5-V power supply is used to power the focusing drive circuit and tracking drive circuit that drive these actuators. The disc motor for driving the optical disc is also generally driven with 5 V. In addition to this 5-V power supply, a 3.3-V power supply is also used to power the DSP (digital signal processor) circuit.

Depending upon the optical disc drive operating conditions, the supply voltage to both the focusing and tracking drive circuits is preferably as high as possible. When the disc motor speed increases, for example, the servo must also accelerate more quickly to the point being tracked on the disc. This requires operating both the focusing and tracking actuators at a higher rate of acceleration, and requires a stronger inductor current. As a result, a high supply voltage is preferable for both the focusing and tracking drive circuits.

Increasing the access speed during optical disc playback requires moving and stopping the light spot at high speed in the tracking direction, and this requires operating the tracking actuator at a high rate of acceleration. This also makes a high supply voltage preferable for the tracking drive circuit.

A high supply voltage is also preferable for the focusing drive circuit when playing a disc with much warp. When playing a disc with much eccentricity, the supply voltage of the tracking drive circuit is preferably high. There are thus various circumstances in which a high power supply voltage is necessary.

The need for faster operation as described above is complicated by strong demand for low power consumption. The drivers for driving the actuators use PWM (pulse width modulation) control instead of linear drive control based on BTL drivers using bipolar transistors. This is because PWM drivers can reduce the power loss resulting from the internal voltage drop of the circuit. Noise output by the PWM driver as a result of high frequency current switching is a problem for the optical disc drive, however, and thus requires a separate arrangement for suppressing such circuit emissions.

More particularly, the playback signal output from the optical pickup can be extremely weak in an optical disc drive that can both read and write. If the PWM driver is used to drive the actuator that moves the objective lens of the optical pickup at this time, electrical noise from the PWM driver will interfere with the playback signal from the optical pickup. This can result in optical disc drive malfunctions and a higher error rate.

To avoid this problem, optical disc drives for both reading and writing quite commonly drive the relatively low frequency, high current consumption disc motor drive circuit with a PWM driver, and drive the relatively low current consumption, high frequency focusing and tracking drive circuits with a linear drive BTL driver.

The product of the current times the difference between the power supply voltage and the voltage actually applied to the actuator in the focusing and tracking drive circuits is lost as heat energy in the BTL driver circuit. When an optical disc is read at low speed, a high power supply voltage is not required for the drive circuit. However, because a high supply voltage is used for the power supply of the drive circuit, a significant amount of power is wasted and excess heat is generated in the linear drive type BTL drive circuits. In other words, if the power supply voltage supplying the drive current is high even though the current required to drive the focusing and tracking actuators is low, power consumption by the power output transistors increases, and heat and power consumption by the chips containing the linear drive type BTL driver become a problem.

Setting the power supply voltage no higher than is necessary is one way to avoid this problem. However, when something with greater deviation than is expected during normal operation occurs, such as when a disc with warping or eccentricity very near the specification limit is inserted to the optical disc drive, the drive current supplied to the actuator that moves the objective lens of the optical pickup becomes insufficient, resulting in operating errors and a higher data error rate. In other words, the ability of the optical disc drive to read and write somewhat non-standard discs deteriorates. There is thus a trade-off between usability and the ability to reduce heat output by lowering the supply voltage.

Recent hybrid driver chips combine the functions of the disc motor drive circuit and focusing and tracking drive circuits in a single device. When the disc motor is driven at high speed, the motor current to the disc motor increases, and power consumption by the disc motor drive circuit in the hybrid driver chip increases. If a high supply voltage is used as the power supply for the focusing and tracking drive circuits at this time, the internal power consumption of the hybrid drive chip increases and the chip temperature rises. If the optical disc drive is used in a high temperature environment, the temperature of the hybrid drive chip may even exceed the maximum temperature limit. The problems of power consumption and heat output are thus tending to become even more pronounced in IC devices having an on-board linear drive type BTL driver and optical disc drives that use such IC devices.

To address these problems and needs, Japanese Unexamined Patent Appl. Pub. 2003-132555 teaches technology for switching the power supply voltage of the focusing and tracking drive circuits according to the operating conditions of the optical disc drive. FIG. 26 is a block diagram showing the optical disc drive taught in Japanese Unexamined Patent Appl. Pub. 2003-132555.

Referring to FIG. 26, the optical pickup 102 emits a light beam to the optical disc 101, and the light reflected from the disc is converted to an electric signal that represents the information on the disc and is output to the playback signal processing circuit 103. The playback signal processing circuit 103 adjusts the amplitude of this playback signal, which is then demodulated by the playback signal demodulation circuit 104 to reproduce the information previously recorded on the optical disc 101.

Rotation of the disc motor 112 is controlled by the disc motor drive circuit 111 based on signals output from the servo circuit 105 according to speed commands from the microcomputer 110, thereby driving the optical disc 101 at a specified speed.

The playback signal processing circuit 103 generates a focus error signal and a tracking error signal. The focus error signal indicates positioning error in the focal point of the laser beam in the focusing direction, and the tracking error signal indicates positioning error in the focal point of the laser beam in the tracking direction.

Based on the focus error signal output by the playback signal processing circuit 103, the servo circuit 105 controls the position of the focal point of the light spot in the focusing direction by the focusing drive circuit 106 and focus actuator 108 so that the light spot is focused on the recording surface of the optical disc 101. This is the focusing servo.

Based on the tracking error signal, the servo circuit 105 controls the position of the focal point of the light beam in the tracking direction by the tracking drive circuit 107 and tracking actuator 109 so that the light spot follows the recording track on the optical disc 101. This is the tracking servo.

In the optical disc drive taught in Japanese Unexamined Patent Appl. Pub. 2003-132555, the power switching circuit 113 switches appropriately according to the operating conditions of the disc drive between the 5V power supply 114 that outputs 5V, the 12V power supply 115 that outputs 12V, and the 3.3V power supply 116 that outputs 3.3V to supply power to the focusing drive circuit 220 and tracking drive circuit 320 and thereby reduce the power consumption of the optical disc drive.

This optical disc drive thus has a first power supply that supplies a first voltage to the focusing drive circuit 106 and tracking drive circuit 107 during normal playback and recording conditions, a second power supply that supplies a second voltage that is different from the first output voltage, and at least one of these power supplies is externally sourced. A switching unit switches to the second power supply from the first power source according to the drive conditions of the focusing and tracking drive circuits 106 and 107.

In order to achieve high speed response and low power consumption using the prior art technology described above in an optical disc drive that is driven by a 5-V power supply, the supply voltage to the focusing and tracking drive circuits is supplied from a first power supply that is used during normal playback and a second power supply that outputs a voltage higher than the first power supply voltage, and switches to the second power supply when fast response is needed. The problem is that switching the focusing and tracking drive circuits between two or three fixed power supply voltages does not achieve a sufficient reduction in power consumption.

An object of the present invention is therefore to increase the operating speed by improving the drive performance of the drive circuit while also reducing drive circuit power consumption.

### SUMMARY OF THE INVENTION

To achieve these objects, a drive apparatus according to a preferred aspect of the invention is an apparatus for supplying drive output to an actuator for operating a movable head. The drive apparatus comprises a fixed output generator operable to produce a predetermined fixed output; a drive output tracking signal generator operable to detect the drive output required to drive the actuator, and to generate a drive output tracking signal that follows the drive output; a step-up type control output generator operable to generate control output that is greater than or equal to the fixed output and slightly greater than the drive output based on the fixed output and the drive output tracking signal; and a drive output generator operable to produce the drive output using the control output.

A drive apparatus according to the present invention can supply control output that is higher than the fixed output by using a step-up type control output generator. The drive output of the drive output generator thus increases when high drive output is needed, the high speed response of the servo thus improves, and drive apparatus usability is improved because the tolerance for disc warp and eccentricity is improved.

Furthermore, because the drive output is generated using the minimum required control output according to the waveform of the drive output required to drive the actuator even though high drive capacity can thus be provided, power consumption can be minimized and heat output from the drive output generator is thus not a problem.

The problem of the trade-off between improving usability and reducing power consumption is thus also solved.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a block diagram of a drive apparatus according to a first embodiment of the invention.

FIG. 2 describes the relationship between control output and drive output in the first embodiment of the invention.

FIG. 3 is a detailed block diagram of a first embodiment of a focusing drive circuit and a first embodiment of a step-up type focusing power supply in the first embodiment shown in FIG. 1.

FIG. 4 is a detailed block diagram of the VB control generator in the first embodiment of the invention.

FIG. 5 shows waveforms (A), (B), (C), and (D), each showing the change in time in main signals shown in FIG. 4.

FIG. 6 is a circuit diagram of the step-up/step-down control circuit in the first embodiment of the invention.

FIG. 7A shows the operating waves of the step-up/step-down type focusing power supply in the first embodiment of the invention.

FIG. 7B shows the operating waves of the step-up/step-down type focusing power supply in the first embodiment of the invention.

FIG. 7C shows the operating waves of the step-up/step-down type focusing power supply in the first embodiment of the invention.

FIG. 7D shows the operating waves of the step-up/step-down type focusing power supply in the first embodiment of the invention.

FIG. 7E shows the operating waves of the step-up/step-down type focusing power supply in the first embodiment of the invention.

FIG. 8A shows the operating waves of the step-up/step-down type focusing power supply in the first embodiment of the invention.

FIG. 8B shows the operating waves of the step-up/step-down type focusing power supply in the first embodiment of the invention.

FIG. 8C shows the operating waves of the step-up/step-down type focusing power supply in the first embodiment of the invention.

FIG. 8D shows the operating waves of the step-up/step-down type focusing power supply in the first embodiment of the invention.

FIG. 8E shows the operating waves of the step-up/step-down type focusing power supply in the first embodiment of the invention.

FIG. 9A describes the operation of the main signals in FIG. 3.

FIG. 9B describes the operation of the main signals in FIG. 3.

FIG. 10 is a detailed block diagram of a second embodiment of a focusing drive circuit in the first embodiment shown in FIG. 1.

FIG. 11 is a circuit diagram of the first peak value detector shown in FIG. 10.

FIG. 12 is a detailed block diagram of a third embodiment of a focusing drive circuit in the first embodiment shown in FIG. 3.

FIG. 13 is a circuit diagram of the peak value detector shown in FIG. 12.

FIG. 14 is a block diagram of the drive apparatus according to a second embodiment of the invention.

FIG. 15 is a detailed block diagram of the drive circuit in the second embodiment the invention.

FIG. 16 is a block diagram of a drive apparatus according to a third embodiment of the invention.

FIG. 17 describes the relationship between control output and drive output in the third embodiment of the invention.

FIG. 18 is a detailed block diagram of the step-up focusing power supply in a third embodiment of the invention.

FIG. 19 is a circuit diagram of the step-up control circuit in the third embodiment of the invention.

FIG. 20A is an operating wave diagram for the step-up focusing power supply in the third embodiment of the invention.

FIG. 20B is an operating wave diagram for the step-up focusing power supply in the third embodiment of the invention.

FIG. 20C is an operating wave diagram for the step-up focusing power supply in the third embodiment of the invention.

FIG. 21A is an operating wave diagram for the step-up focusing power supply in the third embodiment of the invention.

FIG. 21B is an operating wave diagram for the step-up focusing power supply in the third embodiment of the invention.

FIG. 21C is an operating wave diagram for the step-up focusing power supply in the third embodiment of the invention.

FIG. 22A is an operating wave diagram of the main signals shown in FIG. 18, FIG. 16, and FIG. 3.

FIG. 22B is an operating wave diagram of the main signals shown in FIG. 18, FIG. 16, and FIG. 3.

FIG. 23 is a block diagram of a drive apparatus in a fourth embodiment of the invention.

FIG. 24 is a detailed block diagram of the drive circuit in the fourth embodiment of the invention.

FIG. 25 is a block diagram showing a summary of the present invention.

FIG. 26 is a block diagram of a prior art optical disc drive.

### DETAILED DESCRIPTION OF THE PREFERRED EMBODIMENTS

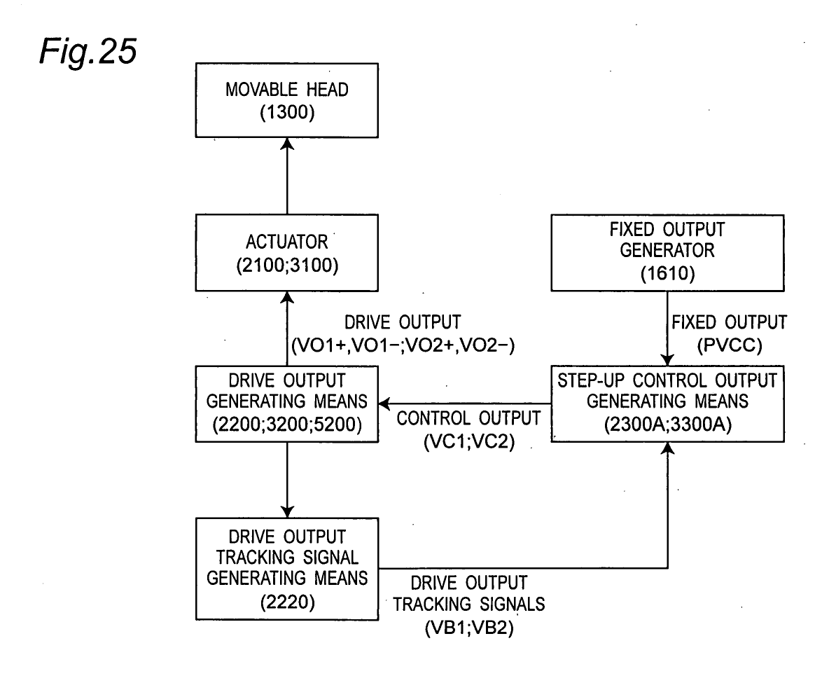

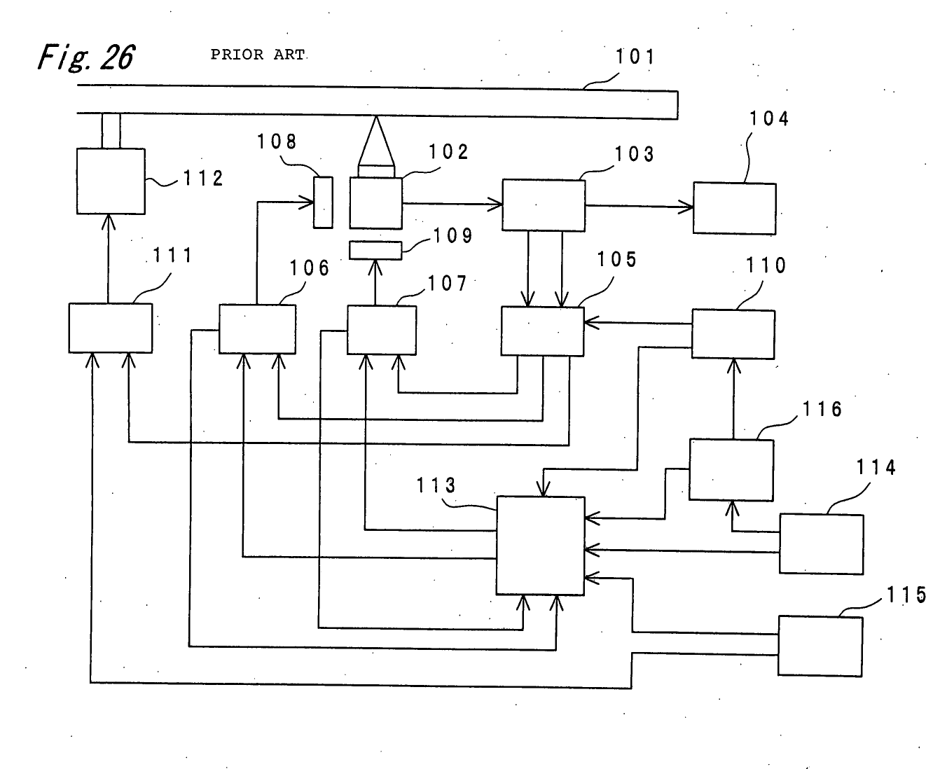

The present invention is described in summary first below with reference to FIG. 25. The fixed output (PVCC) as referred to herein is a DC voltage with sufficient output current such as supplied from a direct current power source with an output voltage of 5 V.

Drive output (VO1+, VO1−; VO2+, VO2−) produced by the drive output generator (2200, 3200, 5200) is supplied to the actuator (2100, 3100) to operate the movable head (1300). The drive output tracking signal generator (2220) detects the drive output (VO1+, VO1−; VO2+, VO2−) required by the actuator (2100, 3100), and generates drive output tracking signals (VB1, VB2) tracking the drive output (VO1+, VO1−; VO2+, VO2−). The step-up type control output generator (2300A, 3300A) controls the fixed output (PVCC) generated by the fixed output generator (1610) based on the drive output tracking signals (VB1, VB2), and produces control output (VC1, VC2) that is greater than or equal to than the fixed output (PVCC) and slightly higher than the drive output (VO1+, VO1−; VO2+, VO2−) when the drive output (VO1+, VO1−; VO2+, VO2−) is greater than or equal to the fixed output (PVCC). The drive output generator (2200, 3200, 5200) uses control output (VC1, VC2) to generate drive output (VO1+, VO1−; VO2+, VO2−).

The lowest control output (VC1, VC2) required to drive the actuator (2100, 3100) can thus be supplied as the power supply of the drive output generator (2200, 3200, 5200) by this arrangement.

Preferred embodiments of this invention are described next below.

It should be noted that the numeric values in the following description of the present invention are used by way of example only to describe the invention, and the invention shall not be limited to these values.

### First Embodiment

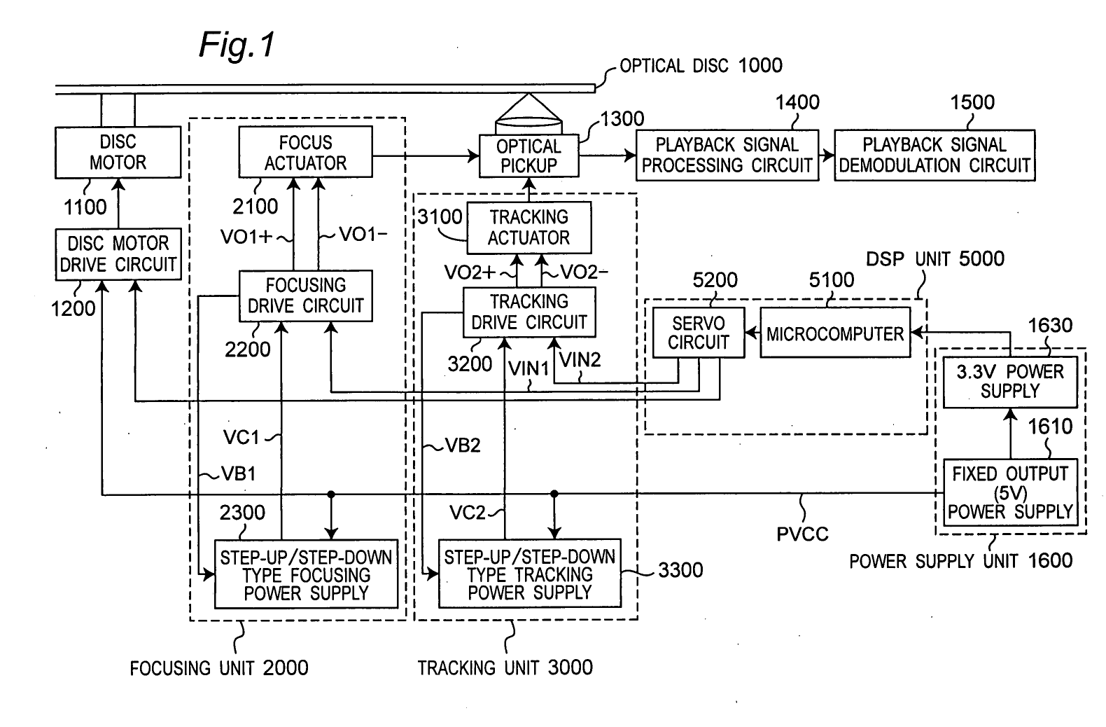

FIG. 1 is a block diagram of a drive apparatus according to a first embodiment of the invention.

Referring to FIG. 1, the optical pickup 1300 emits a light beam to the optical disc 1000, and the light reflected from the disc is converted to an electric signal that represents the information on the disc and is output to the playback signal processing circuit 1400. The playback signal processing circuit 1400 adjusts the amplitude of this playback signal, which is then demodulated by the playback signal demodulation circuit 1500 to reproduce the information previously recorded on the optical disc 1000.

The DSP unit 5000 includes a microcomputer 5100 and servo circuit 5200. Rotation of the disc motor 1100 is controlled by the disc motor drive circuit 1200 based on signals output from the servo circuit 5200 according to speed commands from the microcomputer 5100, thereby driving the optical disc 1000 at a specified speed.

The playback signal processing circuit 1400 generates a focus error signal and a tracking error signal. The focus error signal indicates positioning error in the focal point of the laser beam in the focusing direction, and the tracking error signal indicates positioning error in the focal point of the laser beam in the tracking direction.

Based on the focus error signal output by the playback signal processing circuit 1400, the servo circuit 5200 controls the position of the focal point of the light beam in the focusing direction by the focusing drive circuit 2200 and focus actuator 2100 so that the light beam is focused on the recording surface of the optical disc 1000. This is the focusing servo.

Based on the focus error signal output by the playback signal processing circuit 1400, the servo circuit 5200 controls the position of the focal point of the light spot in the focusing direction by the focusing drive circuit 2200 and focus actuator 2100 so that the light spot is focused on the recording surface of the optical disc 1000. This is the focusing servo.

Based on the tracking error signal, the servo circuit 5200 controls the position of the focal point of the light spot in the tracking direction by the tracking drive circuit 3200 and tracking actuator 3100 so that the light spot follows the recording track on the optical disc 1000. This is the tracking servo.

The focusing unit 2000 comprises the focus actuator 2100, focusing drive circuit 2200, and step-up/step-down type focusing power supply 2300. The tracking unit 3000 comprises the tracking actuator 3100, tracking drive circuit 3200, and step-up/step-down type tracking power supply 3300. The following description of the first embodiment of the invention describes primarily the focusing unit 2000, but the arrangement, operation, and benefits afforded by the tracking unit 3000 are the same.

The focusing drive circuit 2200 produces a drive output tracking signal VB1 according to the drive conditions of the focusing drive circuit 2200, and inputs the drive output tracking signal VB1 to the step-up/step-down type focusing power supply 2300. The supply voltage to the step-up/step-down type focusing power supply 2300 is the fixed output PVCC with an output voltage of 5V, for example, and is supplied from the fixed output (5V) power supply 1610. The step-up/step-down type focusing power supply 2300 converts fixed output PVCC to control output VC1 according to the drive conditions of the focusing drive circuit 2200. Using this control output VC1, the focusing drive circuit 2200 produces and supplies drive outputs VO1+ and VO1− to the focus actuator 2100, thereby driving the focus actuator 2100. Drive outputs VO1+ and VO1−are normally expressed as a voltage but could be expressed as current.

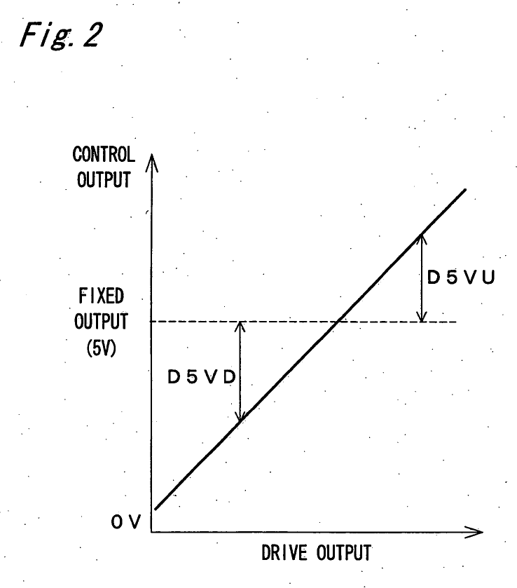

FIG. 2 shows the correlation between control output VC1 from the step-up/step-down type focusing power supply 2300, and the drive outputs VO1+ and VO1− of the focusing drive circuit 2200 in this first embodiment of the invention. Control output VC1 is shown on the y-axis, and drive outputs VO1+ and VO1− are shown on the x-axis. Both axes represent voltage, and control output VC1, drive outputs VO1+ and VO1−, and fixed output PVCC (5V) are all denoted in volts. As noted above, both axes could represent current and control output VC1, drive outputs VO1+ and VO1−, and fixed output PVCC (5V) could all be denoted as current.

As will be known from FIG. 2, if the drive output of the focusing drive circuit 2200 is greater than or equal to fixed output PVCC (5V), a control output VC1 boosted only D5VU from fixed output PVCC (5V) is supplied to the focusing drive circuit 2200, and the step-up/step-down type focusing power supply 2300 thus operates in the step-up mode. If the drive output of the focusing drive circuit 2200 is less than or equal to fixed output PVCC (5V), control output VC1 stepped down only D5VD from fixed output PVCC (5V) is supplied to the focusing drive circuit 2200, and the step-up/step-down type focusing power supply 2300 thus operates in the step-down mode.

While the fixed output PVCC is supplied from a fixed output (5V) power supply 1610 with an output voltage of 5V in this example, a 3.3V power supply 1630 with an output voltage of 3.3 V can be used as the fixed output power supply to further reduce power consumption if this lower voltage power source can produce the maximum drive outputs VO1+ and VO1− required by the focusing drive circuit 2200. The fixed output power source is also not limited to 5V or 3.3V as described here, and can be any desirable voltage.

This embodiment is described above with particular reference to the focusing unit 2000, but the arrangement, operation, and benefits afforded by the tracking unit 3000 are the same.

First Embodiment of the Focus Drive Circuit and First Embodiment of the Step-Up/Step-Down Type Focusing Power Supply

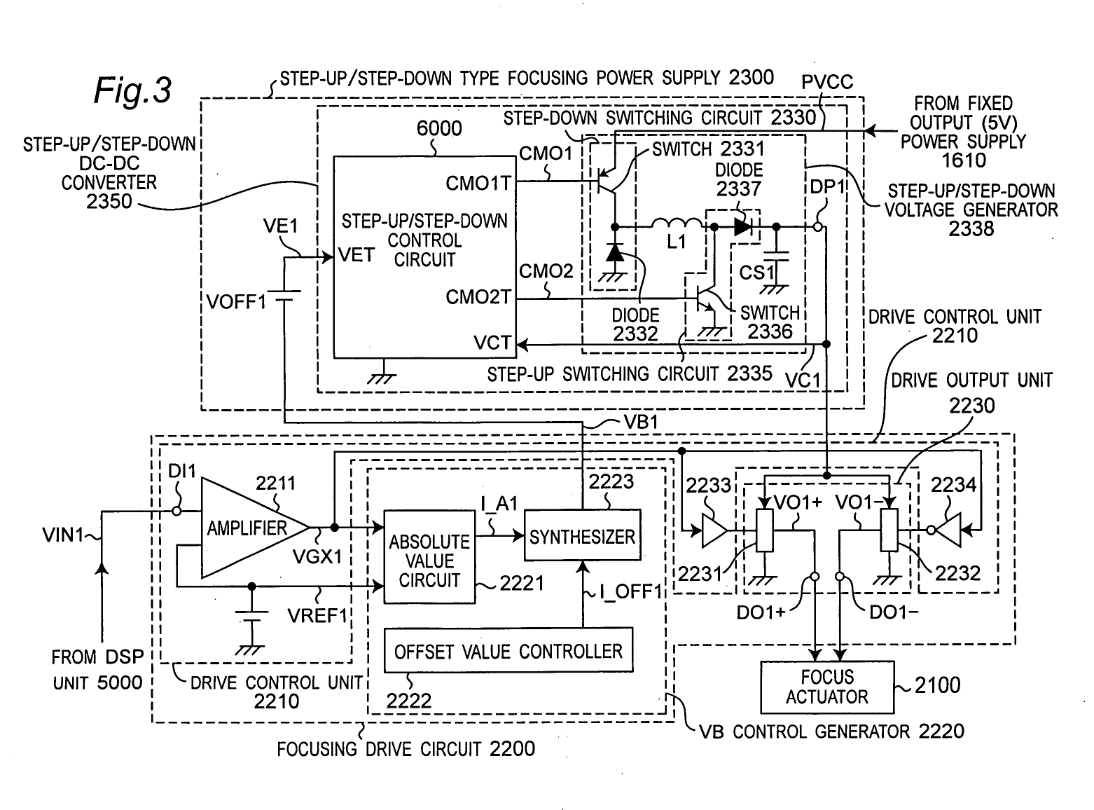

FIG. 3 is a detailed block diagram showing a first embodiment of the focusing drive circuit 2200 and a first embodiment of the step-up/step-down type focusing power supply 2300.

The focusing drive circuit 2200 comprises a drive control unit 2210, a VB control generator 2220, and a drive output unit 2230. The drive output unit 2230 is an H-bridge arrangement of drive output generating elements such as bipolar or MOS transistors. Drivers 2231 and 2232 are each half of this H-bridge construction.

The step-up/step-down type focusing power supply 2300 is the supply power source of the H-bridge drive output unit 2230, and controls the control output VC1 based on the drive output tracking signal VB1 supplied from the VB control generator 2220.

As shown in FIG. 3, drive waveform signal VIN1 containing waveform information for driving the focus actuator 2100 is input to input terminal DI1 from the DSP unit 5000, and the difference between drive waveform signal VIN1 and first reference voltage VREF1 is amplified by an amplifier 2211 with a predetermined amplification rate in the drive control unit 2210. The amplifier output VGX1 and a first reference voltage VREF1 are input to the VB control generator 2220.

In the VB control generator 2220, the amplifier output VGX1 and first reference voltage VREF1 are merged by the absolute value circuit 2221, offset value controller 2222, and synthesizer 2223, and the result is output as drive output tracking signal VB1 to the step-up/step-down type focusing power supply 2300.

The output VGX1 of amplifier 2211 passes through buffer 2233 and inversion buffer 2234, and is input to drive output unit 2230. The drive output unit 2230 contains linear drivers 2231 and 2231. Opposite phase drive output VO1+ and VO1− are generated from the drive output terminals DO1+ and DO1− based on the opposite phase input signals supplied from buffer 2233 and inversion buffer 2234, and the drive outputs VO1+ and VO1− are supplied from the drive output terminals DO1+ and DO1− to the first and second input terminals of the focus actuator 2100.

As shown in equation (1) below, the difference (VO1+)−(VO1−) between drive outputs VO1+ and VO1− is acquired as the difference (VIN1−VREF1) of a specific first reference voltage VREF1 subtracted from the drive waveform signal VIN1 of the drive control unit 2210 multiplied by a predetermined gain G (G>0).
{(VO1+)−(VO1−)}=G*(VIN1−VREF1) (1)

If VIN1>VREF1, then (VO1+)>(VO1−), and if VIN1<VREF1, then (VO1+)<(VO1−).

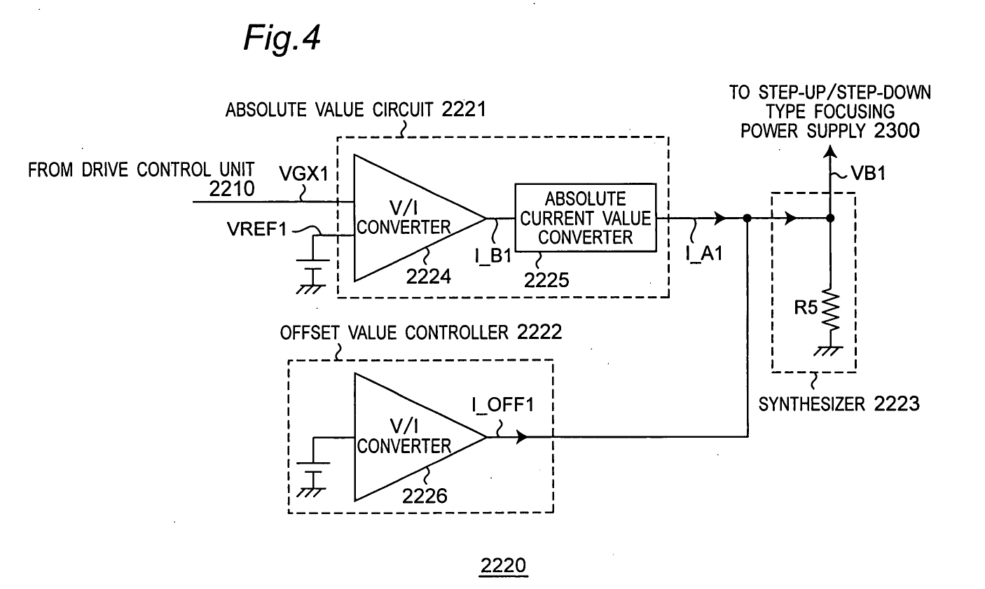

FIG. 4 is a detailed block diagram of the VB control generator 2220 contained in the focusing drive circuit 2200 shown in FIG. 3.

The amplifier output VGX1 from drive control unit 2210 is input to the absolute value circuit 2221, and the voltage difference between amplifier output VGX1 and first reference voltage VREF1 is converted to current by V/I converter 2224. The absolute current value converter 2225 determines the absolute value of the current I_B1 output from the V/I converter 2224, and outputs current I_A1.

The V/I converter 2226 in the offset value controller 2222 converts a predetermined voltage to current and outputs current I_OFF1. This current I_OFF1 is added to current I_A1, and the combined current (I_A1)+(I_OFF1) flows to the resistance R5 in the synthesizer 2223.

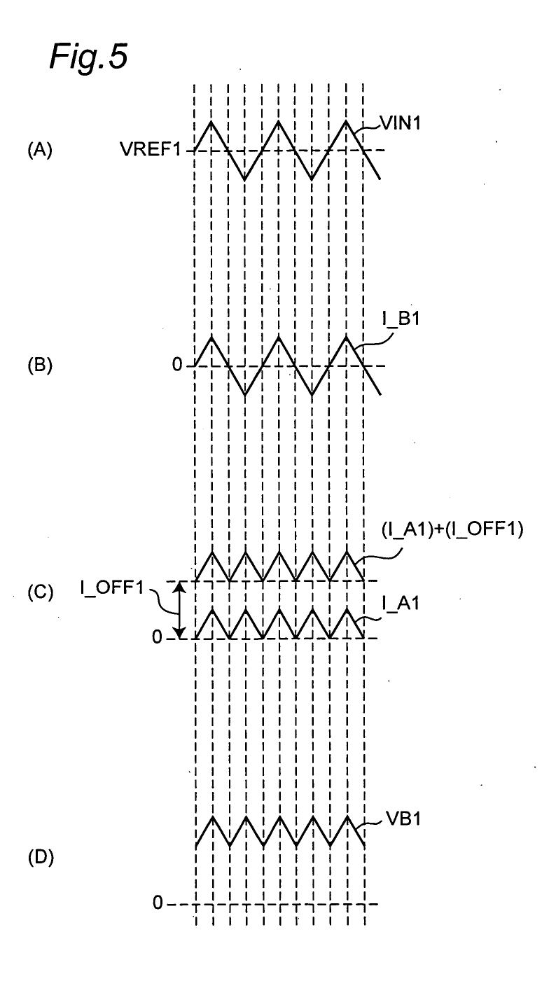

FIG. 5 shows waveforms (A), (B), (C), and (D), each schematically showing the time change in major signals shown in FIG. 4. FIG. 5(A) shows the drive waveform signal VIN1 at input terminal DI1. As shown in FIG. 5(A), drive waveform signal VIN1 is symmetrical to first reference voltage VREF1. FIG. 5(B) shows the waveform of current I_B1, and FIG. 5(C) schematically shows the current I_A1 resulting from the absolute value conversion of current I_B1, and the current (I_A1)+(I_OFF1) combining current I_A1 and current I_OFF1. The voltage of both ends of the resistance R5 is drive output tracking signal VB1, which is shown in FIG. 5(D).

The focusing drive circuit described above thus generates the drive output tracking signal VB1 controlling the control output VC1 of the step-up/step-down type focusing power supply 2300.

A first embodiment of the step-up/step-down type focusing power supply 2300 shown in FIG. 3 is described next.

This first embodiment of the step-up/step-down type focusing power supply 2300 comprises a step-up/step-down DC-DC converter 2350, and the step-up/step-down DC-DC converter 2350 comprises a step-up/step-down control circuit 6000 and step-up/step-down voltage generator 2338.

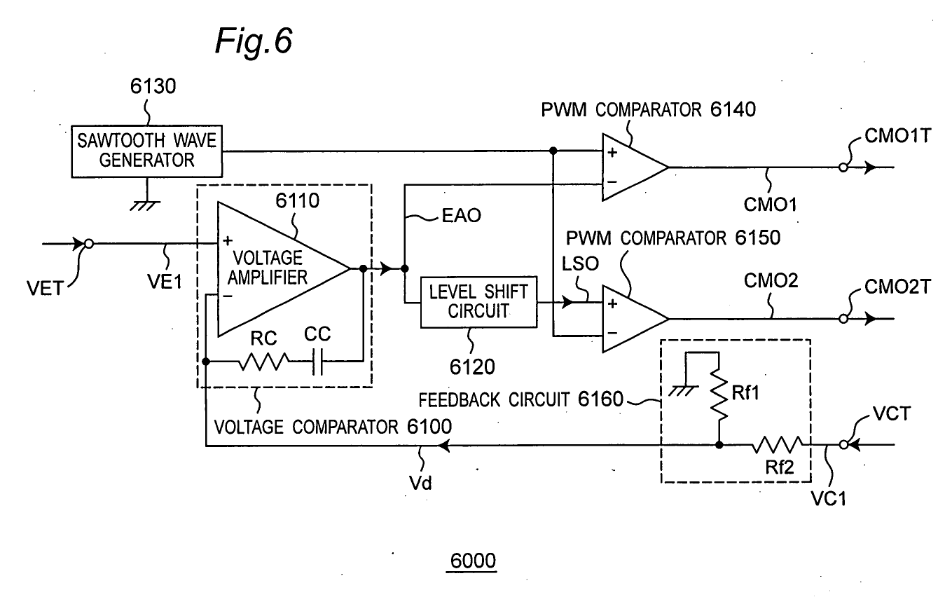

FIG. 6 is a circuit diagram of the step-up/step-down control circuit 6000.

The step-up/step-down control circuit 6000 comprises a voltage comparator 6100, level shift circuit 6120, sawtooth wave generator 6130, PWM comparator 6140, and PWM comparator 6150. The voltage comparator 6100 is composed of a voltage amplifier 6110, resistance RC, and capacitance CC.

The reference voltage input terminal VET of the step-up/step-down control circuit 6000 is connected through the input terminal of the voltage comparator 6100 to the non-inverted input terminal of the voltage amplifier 6110. The output terminal of the voltage amplifier 6110 is connected to the output terminal of the voltage comparator 6100 and one side of capacitance CC. The other side of capacitance CC is connected to one side of resistance RC, and the other side of resistance RC is connected to the inverted input terminal of the voltage amplifier 6110.

The output terminal of the voltage comparator 6100 is connected to the inverted input terminal of PWM comparator 6140 and the input terminal of the level shift circuit 6120. The output terminal of sawtooth wave generator 6130 is connected to the non-inverted input terminal of PWM comparator 6140 and the inverted input terminal of PWM comparator 6150. The output terminal of level shift circuit 6120 is connected to the non-inverted input terminal of PWM comparator 6150. The output terminal of PWM comparator 6140 and the output terminal of PWM comparator 6150 are respectively connected to output terminal CMO1T and output terminal CMO2T of step-up/step-down control circuit 6000.

Another input terminal VCT to step-up/step-down control circuit 6000 is the input node to feedback circuit 6160, and the output node of the feedback circuit 6160 is connected to the inverted input terminal of voltage amplifier 6110 through another input terminal to the voltage comparator 6100. The input node of the feedback circuit 6160 is connected to one side of resistance Rf2. The other side of resistance Rf2 is connected to one side of resistance Rf1 and the output terminal of feedback circuit 6160, and the other side of resistance Rf1 is to ground.

The step-up/step-down voltage generator 2338 in the step-up/step-down DC-DC converter 2350 shown in FIG. 3 comprises step-down switching circuit 2330, inductor L1, step-up switching circuit 2335, and capacitor CS1.

The output terminal CMO1T of step-up/step-down control circuit 6000 is connected to the control input terminal that controls the step-down switching circuit 2330 contained in the step-up/step-down voltage generator 2338. The step-down switching circuit 2330 is composed of a pnp transistor switch 2331 and a regeneration current diode 2332. The base of switch 2331 is the control input terminal noted above and is connected to output terminal CMO1T of step-up/step-down control circuit 6000. The emitter of the switch 2331 is connected to the fixed output PVCC (5V) power supply 1610, and the collector is connected to the cathode of diode 2332, of which the anode is to ground, and one side of inductor L1.

The other side of inductor L1 is connected to step-up switching circuit 2335. The step-up switching circuit 2335 comprises an npn transistor switch 2336 and rectifying diode 2337. The base of switch 2336 is the control input terminal of step-up switching circuit 2335 and is connected to output terminal CMO2T of step-up/step-down control circuit 6000. The emitter is to ground, and the collector is connected to the other side of inductor L1 and to the anode of diode 2337. A smoothing capacitor CS1 has one end to ground. The cathode of diode 2337 is connected to the other end of capacitor CS1 and to control output terminal DP1. This control output terminal DP1 is the output terminal of step-up/step-down DC-DC converter 2350 and step-up/step-down type focusing power supply 2300, and is connected to the input terminal VCT of step-up/step-down control circuit 6000.

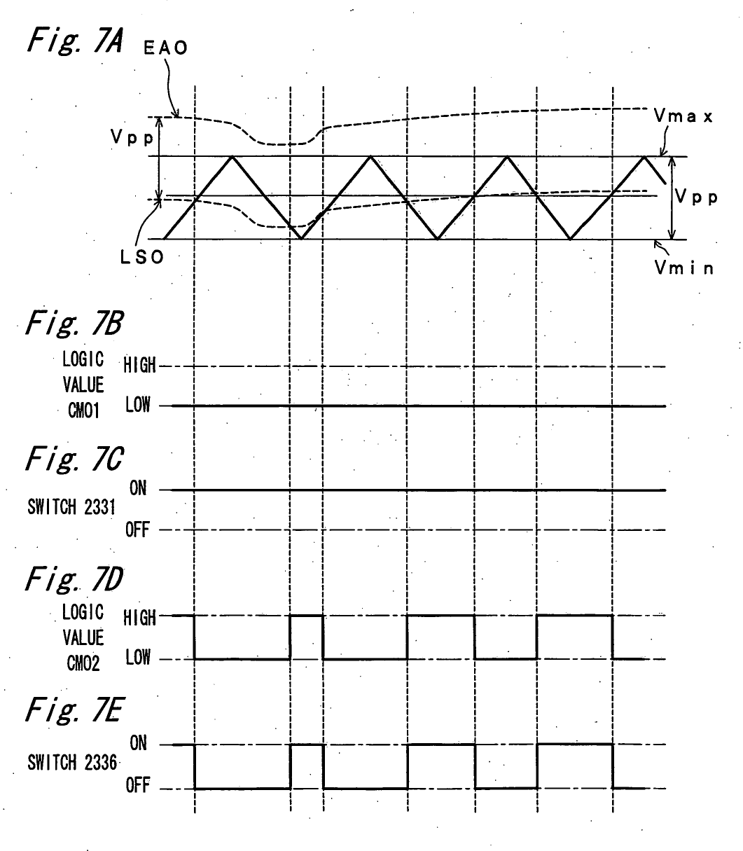

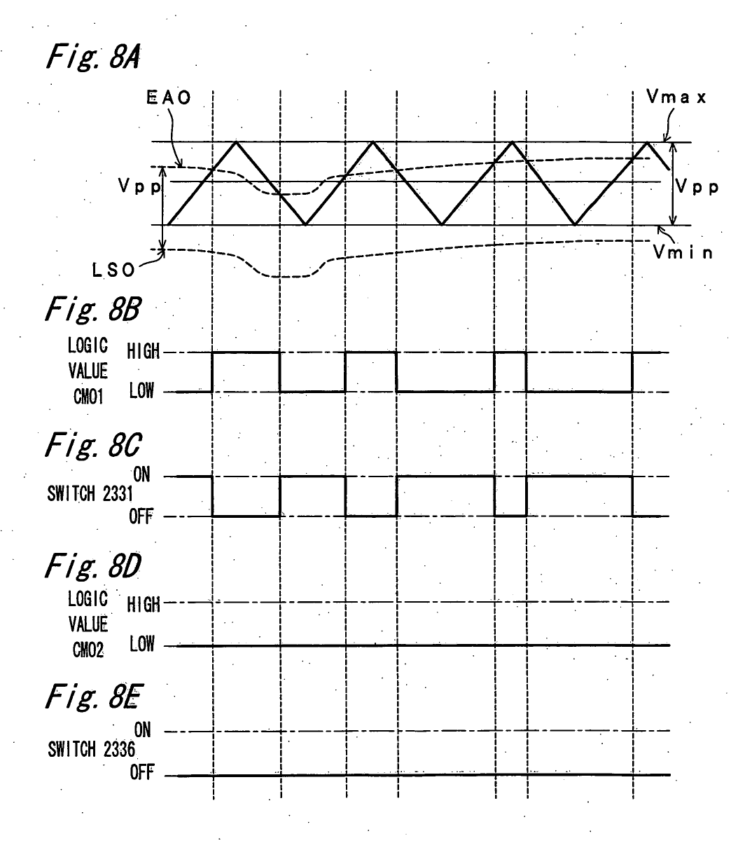

Operation of this step-up/step-down DC-DC converter 2350 is described next with reference to FIG. 3 and FIG. 6 and the operating wave diagrams shown in FIG. 7 and FIG. 8.

The control output VC1 from control output terminal DP1 is applied through feedback circuit 6160 to the inverted input terminal of voltage comparator 6100 as feedback voltage Vd. The relationship between feedback voltage Vd and control output VC1 is defined by equation (2).
Vd=((Rf1/(Rf1+Rf2))*VC1 (2)

The voltage comparator 6100 compares second reference voltage VE1 and feedback voltage Vd, and the resulting voltage difference EAO is sent to PWM comparator 6140 and level shift circuit 6120. Capacitance CC and resistance RC render a phase compensation function affording stable operation of the step-up/step-down DC-DC converter 2350. A sawtooth wave of minimum potential Vmin, maximum potential Vmax, and amplitude Vpp(=Vmax−Vmin) is sent from sawtooth wave generator 6130 to PWM comparator 6140 and PWM comparator 6150. The voltage difference EAO is reduced the amplitude Vpp of the sawtooth wave by level shift circuit 6120 and then applied as voltage LSO to PWM comparator 6150.

While voltage LSO is amplitude Vpp lower than the output voltage of voltage comparator 6100 in this example, a level shifter could also be disposed to the input of the PWM comparator 6140 to raise the potential by half of amplitude Vpp, for example, so that level shift circuit 6120 lowers the potential by only half of amplitude Vpp. The level shift rendered by these two level shifters is also not limited to these values and can be set desirably.

The sawtooth wave, voltage difference EAO, and voltage LSO are compared by PWM comparators 6140 and 6150, and the results are sent as logic values CMO1 and CMO2 to step-down switching circuit 2330 and step-up switching circuit 2335.

FIG. 7 shows the operating wave when Vd<=VE1. When PWM comparators 6140 and 6150 determine that Vmin<LSO<Vmax and Vmax<EAO as shown in FIG. 7A, logic values CMO1 and CMO2 are as shown in FIG. 7B and FIG. 7D, respectively.

FIG. 8 shows the operating waves when VE1<Vd. In this case PWM comparators 6140 and 6150 determine that LSO<Vmin and Vmin<EAO<Vmax as shown in FIG. 8A, and logic values CMO1 and CMO2 are as shown in FIG. 8B and FIG. 8D, respectively.

Logic values CMO1 and CMO2 thus determine whether the step-up/step-down DC-DC converter 2350 operates in the step-up or step-down mode.

When logic value CMO1 is LOW, switch 2331 is ON. If logic value CMO2 then goes HIGH and LOW synchronized to the period of the sawtooth wave, switch 2336 repeatedly switches ON and OFF. At this time the step-down switching circuit 2330 side of the inductor L1 goes to the same potential as fixed output PVCC, and the other side switches between 0V and 5V synchronized to the period of the sawtooth wave. When the other side is 0V, the inductor L1 stores energy, and when the other side is 5V, the inductor L1 discharges the energy to capacitor CS1. The control output VC1 is thus stepped up because the voltage equivalent of this energy is added to the 5V.

When logic value CMO2 is LOW, switch 2336 is OFF. If logic value CMO1 then goes HIGH and LOW synchronized to the period of the sawtooth wave, switch 2331 repeatedly switches ON and OFF. The output of step-down switching circuit 2330 thus switches between 0V and 5V synchronized to the period of the sawtooth wave. The control output VC1 is thus stepped down because the 5V supply is reduced proportionally to the duration of the 0V period.

FIG. 7C and FIG. 7E, and FIG. 8C and FIG. 8E show the state of switch 2331 and switch 2336 during this operation.

The amount of the step-up or step-down is determined by the on/off duty ratio of the switches 2331 and 2336, which operates at the period of the sawtooth wave based on the results from the PWM comparators 6140 and 6150. When operating in the step-up mode, the voltage boost increases as the ratio of the ON period of switch 2336 increases. When operating in the step-down mode, the voltage drop increases as the ratio of the ON period of switch 2331 decreases.

The step-up/step-down DC-DC converter 2350 thus operates in a step-up mode when Vd<=VE1 and in a step-down mode when VE1<Vd, and thereby works to drive feedback voltage Vd equal to second reference voltage VE1. As will be known from equation (2), control output VC1 thus converges to second reference voltage VE1 to satisfy equation (3) shown below.
VC1=((Rf1+Rf2)/Rf1)*VE1 (3)

The step-up/step-down DC-DC converter 2350 thus comprises a feedback circuit 6160 that generates feedback voltage Vd proportionally to control output VC1 and less than or equal to control output VC1; a voltage comparator 6100 that compares second reference voltage VE1 and feedback voltage Vd, and generates both voltage differences EAO and LSO; a plurality of PWM comparators 6140 and 6150 that convert both voltage differences EAO, LSO to PWM signals CMO1 and CMO2; and step-up/step-down voltage generator 2338 that switches and converts the fixed output PVCC to control output VC1 based on the plural PWM signals CMO1, CMO2. The step-up/step-down voltage generator 2338 comprises step-up switching circuit 2335, step-down switching circuit 2330, inductor L1, and capacitor CS1, control output VC1 is output from both sides of capacitor CS1.

In addition, the step-up/step-down DC-DC converter 2350 in the step-up/step-down type focusing power supply 2300 controls fixed output PVCC based on drive output tracking signal VB1 and produces control output VC1 corresponding to second reference voltage VE1 as a result of applying the voltage sum of drive output tracking signal VB1 and tracking signal offset voltage VOFF1 as second reference voltage VE1 to reference voltage input terminal VET. If the drive output is greater than or equal to fixed output PVCC, control output VC1 is boosted to fixed output PVCC or greater in a step-up mode to satisfy equation (4). If the drive output is less than or equal to fixed output PVCC, control output VC1 is stepped down to fixed output PVCC or less in a step-down mode operation.
VC1=((Rf1+Rf2)/Rf1)*(VB1+VOFF1) (4)

By appropriately setting tracking signal offset voltage VOFF1, control output VC1 can also be set slightly higher than the drive output. Furthermore, if drive output tracking signal VB1 varies according to drive waveform signal VIN1, control output VC1 also varies accordingly.

The switch 2331 and diode 2332 composing the step-down switching circuit 2330 shown in FIG. 3 can be replaced by two MOS power transistors, and the two MOS power transistors can be operated using a synchronous rectifier method. The switch 2336 and diode 2337 composing the step-up switching circuit 2335 can also be replaced with two MOS power transistors, and the two MOS power transistors can be operated using a synchronous rectifier method. In this case the step-up/step-down control circuit 6000 is arranged to control these two synchronous rectifier MOS power transistors as described above.

A p-channel MOS transistor and n-channel MOS transistor can also be used instead for switch 2331 and switch 2336, respectively, thus enabling a switching operation using MOS switches.

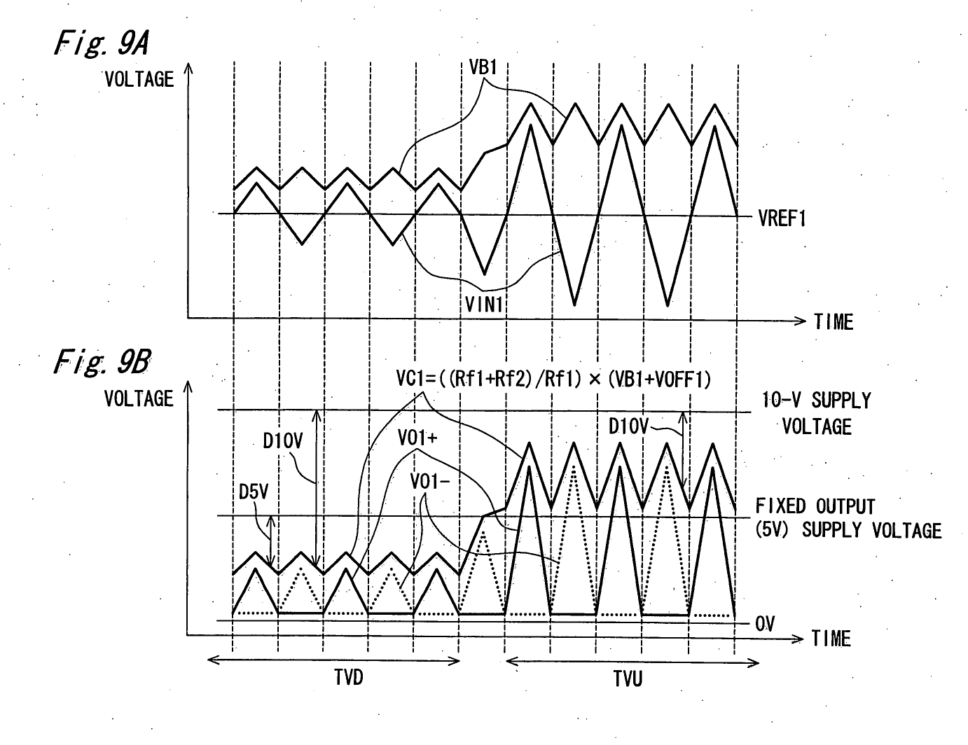

FIG. 9 is a waveform diagram showing the main signals described in FIG. 3. FIG. 9A is a waveform diagram of the drive output tracking signal VB1, first reference voltage VREF1, and drive waveform signal VIN1. FIG. 9B is a waveform diagram of the control output VC1 and drive outputs VO1+ and VO1− in step-up period TVU and step-down period TVD. Voltage is on the y-axis in FIG. 9, but the signals could be expressed as current instead.

As will be known from the arrangement described above, the drive output tracking signal VB1 shown in FIG. 9A is the absolute value of drive waveform signal VIN1 relative to the first reference voltage VREF1 plus a predetermined voltage. The second reference voltage VE1 at the reference voltage input terminal VET of the step-up/step-down DC-DC converter 2350 is thus (VB1+VOFF1).

As a result, the control output VC1 tracking the second reference voltage VE1 in FIG. 9B is defined by equation (4). The control output VC1 wave is therefore slightly larger than drive output VO1+ and VO1− following the peak drive outputs VO1+ and VO1−, which are output in a balanced mode by the drive output generating elements.

What the control output VC1 wave being slight larger than drive output VO1+ and VO1− means is described next. From a perspective, the control output VC1 wave is slightly higher than drive output VO1+ and VO1− and the waveforms are roughly the same near the peak of the drive output VO1+ and VO1− as shown in FIG. 9B. Thus, if the tracking signal offset voltage VOFF1 is set appropriately (to zero or any appropriate positive or negative level), the tracking signal offset voltage VOFF1 can be minimized without adversely affecting the drive output VO1+ and VO1− produced by the drive output generating element.

The control output VC1 is boosted from fixed output PVCC in the step-up period TVU, but consumes less power and produces less heat than linear drive output generating elements that simply output difference voltage D10V from a 10-V power source in an arrangement that supplies a 10-V power supply directly to the drive output generating elements. Furthermore, in step-down period TVD, control output VC1 is stepped down from fixed output PVCC, but this also consumes less power and produces less heat than linear drive output generating elements in an arrangement that supplies 5-V directly to the drive output generating elements which then output difference voltage D5V from the 5-V power source or difference voltage D10V from a 10-V power source when a 10-V power source is used instead of a 5-V power source.

Second Embodiment of the Focusing Drive Circuit

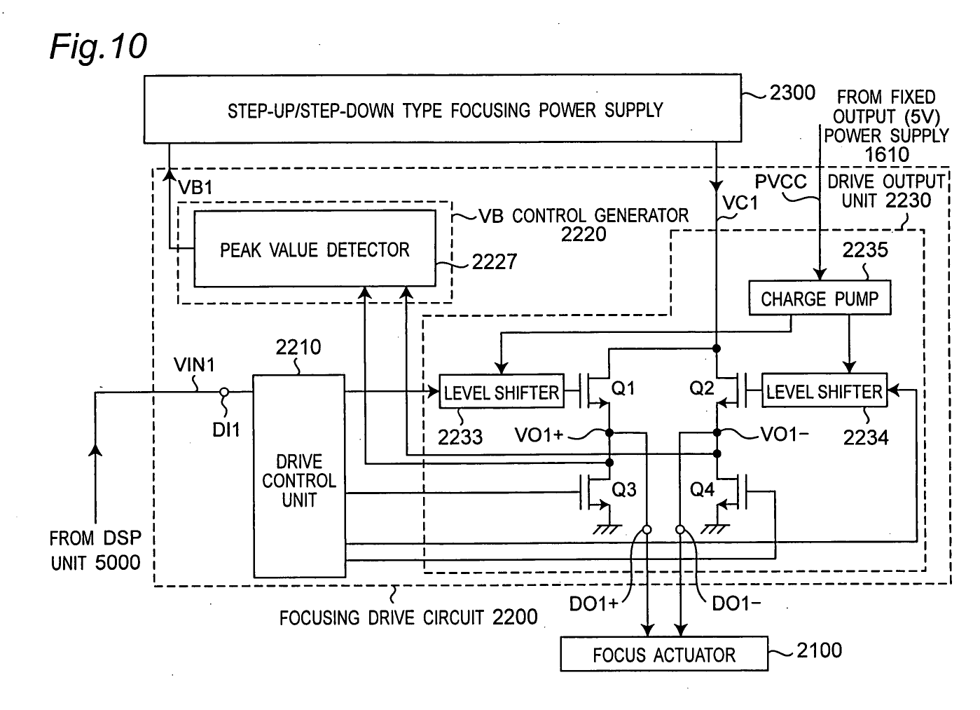

FIG. 10 is a detailed block diagram of a second embodiment of the focusing drive circuit 2200 in the first embodiment of the invention shown in FIG. 1.

This second embodiment of the focusing drive circuit 2200 is composed of drive control unit 2210, VB control generator 2220, and drive output unit 2230. The drive output unit 2230 is composed of four linear drive output generating elements, which are n-channel MOS transistors in this example, in an H bridge arrangement; level shifters 2233 and 2234 for driving the gate of the n-channel MOS transistors; and a charge pump 2235 for supplying power to the level shifters 2233 and 2234 using fixed output PVCC.

The VB control generator 2220 includes a peak value detector 2227, and the drive output tracking signal VB1 output from the peak value detector 2227 is supplied to step-up/step-down type focusing power supply 2300. The control output VC1 is controlled according to drive output tracking signal VB1.

The H bridge is composed of two n-channel MOS transistors Q1 and Q2 shown on the top in FIG. 9, and two n-channel MOS transistors Q3 and Q4 on the bottom. The node between the n-channel MOS transistor Q1 source and the n-channel MOS transistor Q3 drain, and the node between the n-channel MOS transistor Q2 source and n-channel MOS transistor Q4 drain, are drive output terminals DO1+ and DO1−. The drive outputs VO1+ and VO1− are output from these two drive output terminals DO1+ and DO1− to the first and second input terminals of the focus actuator 2100.

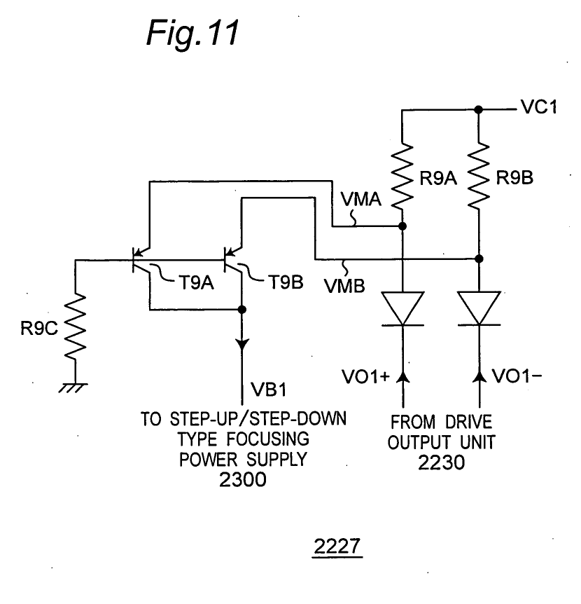

FIG. 11 is a circuit diagram of the peak value detector 2227 shown in FIG. 10. In FIG. 11 drive outputs VO1+ and VO1− shown in FIG. 10 are boosted by the forward diode voltage and then detected as voltages VMA and VMB, and voltage VMA and voltage VMB are input to transistors T9A and T9B, respectively. Because the bases of transistors T9A and T9B go to a common ground through resistance R9C, voltage VMA and voltage VMB are compared, and the maximum of these two voltages, that is, the higher voltage, is output as drive output tracking signal VB1 to the step-up/step-down type focusing power supply 2300. Drive output tracking signal VB1 is thus a signal equal to the peak value enveloping these two voltages VMA and VMB.

Because the control output VC1 of the step-up/step-down type focusing power supply 2300 is thus the supply voltage to the drive output generating elements Q1, Q2, Q3, Q4 of the focusing drive circuit, the power consumption and heat output of the linear drive output generating elements (n-channel MOS transistors in this embodiment of the invention) can be suppressed by appropriately setting the tracking signal offset voltage VOFF1 level (to zero or an appropriate positive or negative value) while being able to supply the current needed to drive the focus actuator 2100.

Third Embodiment of the Focusing Drive Circuit

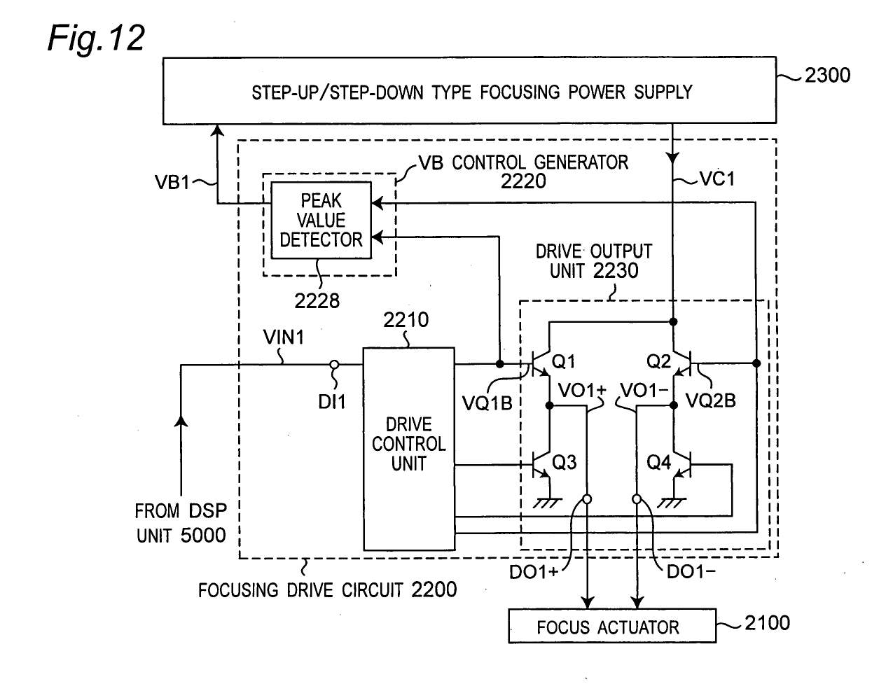

FIG. 12 is a detailed block diagram showing a third embodiment of the focusing drive circuit 2200 in the first embodiment of the invention shown in FIG. 1. This focusing drive circuit 2200 comprises drive control unit 2210, VB control generator 2220, and drive output unit 2230. The drive output unit 2230 is a linear drive H-bridge arrangement of npn transistors Q1, Q2, Q3, Q4, which are the drive output generating elements.

The VB control generator 2220 comprises a peak value detector 2228, and the drive output tracking signal VB1 output from the peak value detector 2228 is supplied to the step-up/step-down type focusing power supply 2300. The control output VC1 is controlled according to drive output tracking signal VB1.

The H bridge is composed of two npn transistors Q1 and Q2 shown on the top, and two npn transistors Q3 and Q4 on the bottom. The node between npn transistor Q1 emitter and npn transistor Q3 collector, and the node between npn transistor Q2 emitter and npn transistor Q4 collector, are drive output terminals DO1+ and DO1−. The drive outputs VO1+ and VO1− are output from these two drive output terminals DO1+ and DO1− to the first and second input terminals of the focus actuator 2100.

The base voltage VQ1B of transistor Q1 in FIG. 12 is greater than the drive output VO1+ by the voltage between the base and emitter of Q1, and base voltage VQ2B of transistor Q2 is greater than the drive output VO1− by the voltage between the base and emitter of Q2.

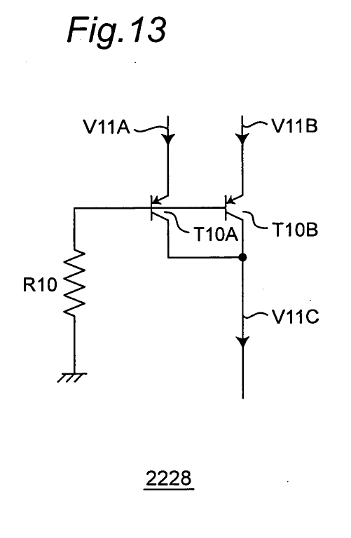

FIG. 11 is a circuit diagram of the peak value detector 2228 shown in FIG. 12. The peak value detector 2228 is the same as the latter part of the peak value detector 2227 in FIG. 11, and voltage VQ1B and voltage VQ2B in FIG. 12 are applied as the emitter terminal voltages V11A and V11B of transistors T10A and T10B in FIG. 13. Because the base terminals of transistors T10A and T10B go to a common ground through resistance R10, voltage V11A and voltage V11B are compared, and the peak value, that is, the greater of the two voltages, is output as common collector voltage V11C. This collector voltage V11C is the drive output tracking signal VB1 shown in FIG. 12, and is output to the step-up/step-down type focusing power supply 2300. Drive output tracking signal VB1 is thus a peak value signal equal to the peak value of these two voltages VMA and VMB.

As in the second embodiment shown in FIG. 10, the power consumption and heat output of the linear drive output generating elements (npn transistors in this embodiment of the invention) can be suppressed by appropriately setting the tracking signal offset voltage VOFF1 level (to zero or an appropriate positive or negative value) while being able to supply the current needed to drive the focus actuator 2100.

The first, second, and third embodiments of the focusing drive circuit shown in FIG. 3, FIG. 10, and FIG. 12, respectively, are compared below.

In the first embodiment the drive output tracking signal VB1 is generated in an open loop. In the second and third embodiments, however, drive output tracking signal VB1 is produced with feedback from the drive output unit 2230 being controlled, and signal generation is thus done in a closed loop.

In order to drive the focus actuator 2100 with fast response according to the drive conditions of the focusing drive circuit 2200, it is also necessary to know the required supply power characteristics of the focusing drive circuit 2200 and information from the servo circuit 5200 about previous operation as early as possible. As a result, the first embodiment can detect the drive output tracking signal VB1 with better response than can the second and third embodiments. The third embodiment detects the drive output tracking signal VB1 from the base nodes of the drive output generating elements, and can thus detect the drive output tracking signal VB1 slightly sooner than the second embodiment can detect the drive output of the drive output generating elements.

Linear drive type drive output generating elements are used in the first embodiment of the invention as described above. This prevents generating unnecessary high frequency noise, eliminates the need for a special electromagnetic shield that is difficult to render and requires tuning, and thus affords stable focusing and improves the playback error rate.

Furthermore, the step-up/step-down type focusing power supply 2300 enables supplying control output VC1 that is higher than fixed output PVCC. When high drive output VO1+ and VO1− is required, this improves the drive capacity of the focusing drive circuit 2200 and improves high speed servo response, thereby increasing tolerance for disc warp and eccentricity, and thus improving the usability of the drive apparatus. The ability to accommodate a heavier objective lens is also improved.

Operation with minimal power consumption is also possible and heat output from the drive output generating elements is not a problem because the drive output is produced using the minimum necessary control output VC1 tracking the drive outputs VO1+ and VO1− while also affording improved drive capacity.

Yet further, if low drive output is sufficient, control output VC1 is also reduced and power consumption is yet further reduced.

Whether drive outputs VO1+ and VO1− are greater than or less than fixed output PVCC, control output VC1 can be set to the minimum required level following the drive outputs VO1+ and VO1− by automatically switching the step-up and step-down operation, and the required drive output VO1+ and VO1− can be supplied to the focus actuator 2100 with minimum power consumption regardless of the fixed output PVCC level.

The problem of the trade-off between reducing power consumption and improving usability is thus solved.

The first embodiment above is described with particular reference to the focusing unit 2000 shown in FIG. 1, but the tracking unit 3000 features the same arrangement and operation as the focusing unit 2000 and therefore also affords the same benefits.

Arrangements having more than one focusing unit 2000 or tracking unit 3000 will also afford the same benefits as a result of having the same arrangement and operation.

### Second Embodiment

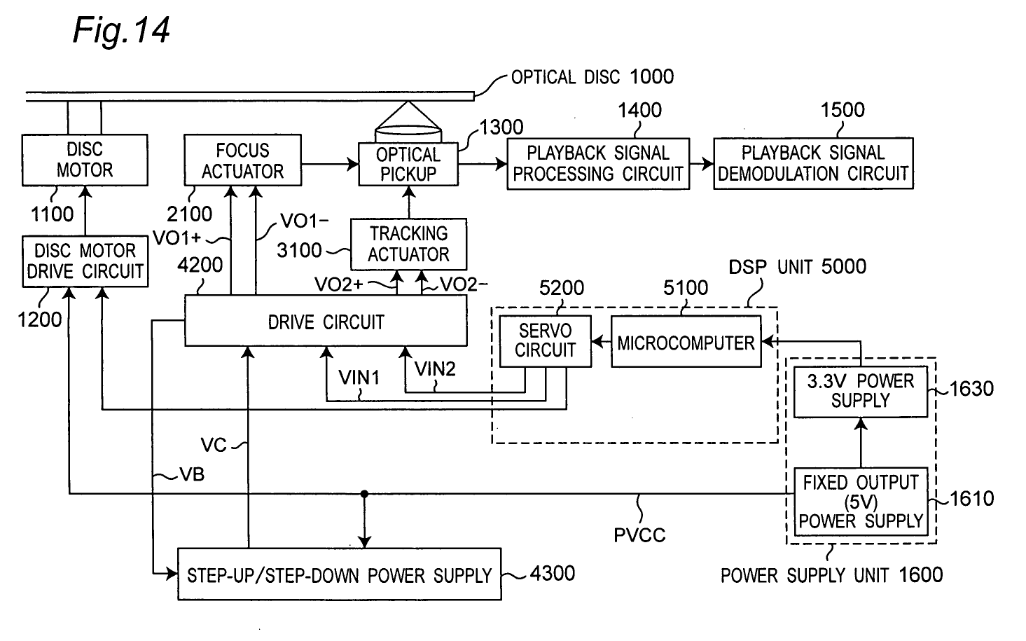

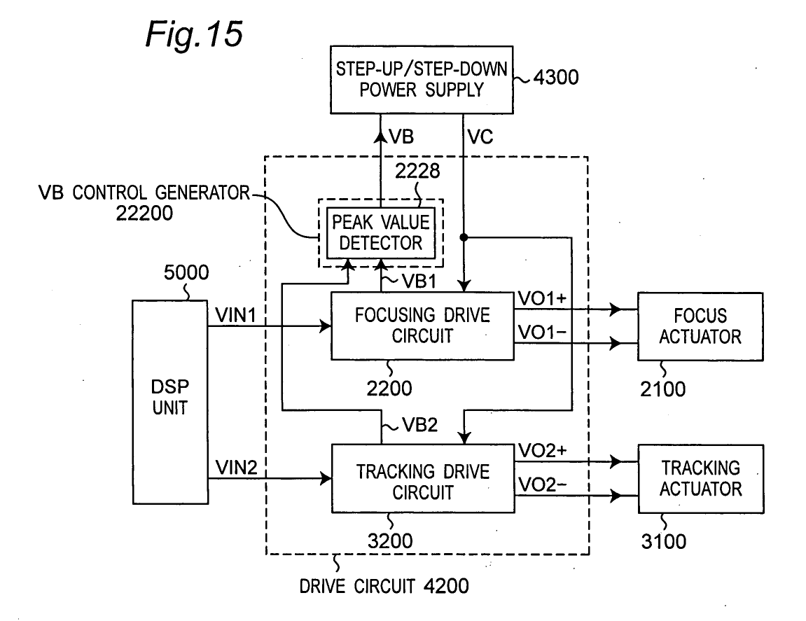

FIG. 14 is a block diagram of a drive apparatus according to a second embodiment of the invention. FIG. 15 is a block diagram of the drive circuit 4200 in the second embodiment shown in FIG. 14. The second embodiment shown in FIG. 14 differs from the first embodiment shown in FIG. 1 in that the step-up/step-down type focusing power supply 2300 and step-up/step-down type tracking power supply 3300 are combined into a single step-up/step-down power supply 4300, and the focusing drive circuit 2200 and tracking drive circuit 3200 are combined into a single drive circuit 4200.

While a step-up/step-down power supply 4300 of the same arrangement is provided separately for the focusing unit 2000 and tracking unit 3000 in the first embodiment shown in FIG. 1, the system requires only one in this second embodiment shown in FIG. 14. Therefore, the arrangement, operation, and effect of step-up/step-down type focusing power supply 2300, step-up/step-down type tracking power supply 3300, and step-up/step-down power supply 4300 are the same. The step-up/step-down power supply 4300 also contains a tracking signal offset voltage VOFF that is identical in structure, operation, and effect as the tracking signal offset voltage VOFF1 of the step-up/step-down type focusing power supply 2300.

The drive circuit 4200 shown in FIG. 15 is basically the same as the drive circuits in the first embodiment shown in FIG. 1, and has focusing drive circuit 2200 and tracking drive circuit 3200. The focusing drive circuit 2200 and tracking drive circuit 3200 can be rendered in the same way as the first embodiment of a focusing drive circuit shown in FIG. 3, the second embodiment of a focusing drive circuit shown in FIG. 10, or the third embodiment of a focusing drive circuit as shown in FIG. 12.

Regarding the drive output tracking signal, a VB control generator 2220 is rendered in both the focusing drive circuit 2200 and tracking drive circuit 3200 in FIG. 15. These two VB control generators 2220 respectively output drive output tracking signals VB1 and VB2. The peak value detector 2228, which is a specific embodiment of VB control generator 22200, is arranged as previously described with reference to FIG. 13, and outputs the peak value of secondary drive output tracking signals VB1 and VB2, that is, the higher of the two voltages, as drive output tracking signal VB to the step-up/step-down power supply 4300. The drive output tracking signal VB is a signal equal to the maximum value of and includes these two secondary drive output tracking signals VB1, VB2.

Furthermore, because the control output VC of the step-up/step-down power supply 4300 is the supply voltage of the drive output generating elements contained in focusing drive circuit 2200 and tracking drive circuit 3200, power consumption and heat output by the linear drive output generating elements can be suppressed by appropriately setting the tracking signal offset voltage VOFF (to zero or a desirable positive or negative value) while still supplying the current required to drive focus actuator 2100 and tracking actuator 3100.

In this second embodiment of the invention the two VB control generators 2220 in the focusing drive circuit 2200 and tracking drive circuit 3200 are referred to as “secondary drive output tracking signal generator” and the VB control generator 22200 is referred to as a “wrapping arrangement”.

The step-up/step-down type focusing power supply 4300 thus enables supplying control output VC that is higher than fixed output PVCC. When high drive output VO1+, VO1−, VO2+, VO2− is required, this improves the drive capacity of the drive circuit 4200 and improves high speed servo response, thereby increasing tolerance for disc warp and eccentricity, and thus improving the usability of the drive apparatus. The ability to accommodate a heavier objective lens is also improved.

Operation with minimal power consumption is also possible and heat output from the drive output generating elements is not a problem because the drive output is produced using the minimum necessary control output VC tracking the drive outputs VO1+, VO1−, VO2+, VO2− while also affording improved drive capacity.

Yet further, if low drive output is sufficient, control output VC is also reduced and power consumption is yet further reduced.

Whether drive output VO1+, VO1−, VO2+, VO2− is greater than or less than fixed output PVCC, control output VC can be set to the minimum required level following the drive output VO1+, VO1−, VO2+, VO2− by automatically switching the step-up and step-down operation, and the required drive output VO1+, VO1−, VO2+, VO2− can be supplied to the focus and tracking actuators 2100 and 3100 with minimum power consumption regardless of the fixed output PVCC level.

This second embodiment of the invention also simplifies the construction and lowers the cost of the drive apparatus by using just one step-up/step-down power supply 4300 as the power supply generating the control output VC supplied to the focusing and tracking drive circuits 2200 and 3200.

The problem of the trade-off between reducing power consumption and improving usability is thus solved.

### Third Embodiment

In the first and second embodiments of the invention step-up/step-down type focusing and tracking power supplies 2300 and 3300 or step-up/step-down power supply 4300 are used as the power source supplying control output VC1 and VC2 to focusing and tracking drive circuits 2200 and 3200. Third and fourth embodiments of the invention use step-up focusing and tracking power supplies 2300A and 3300A or step-up power supply 4300A.

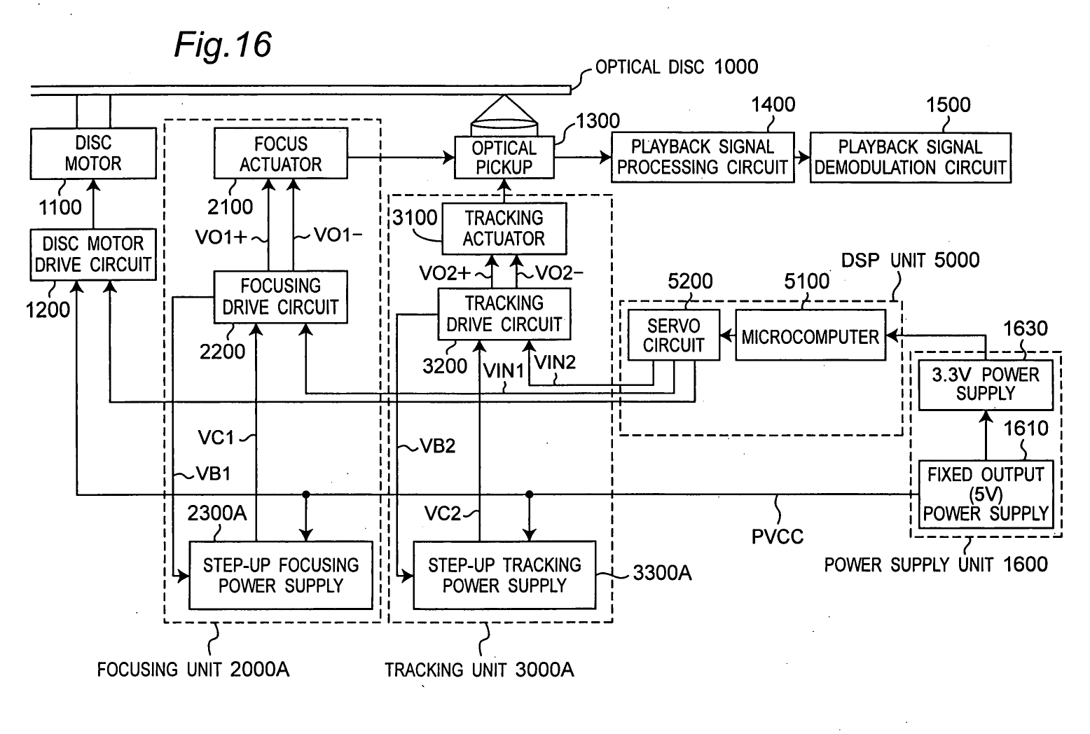

FIG. 16 is a block diagram of a drive apparatus according to a third embodiment of the invention.

The third embodiment shown in FIG. 16 differs from the first embodiment in FIG. 1 in that focusing unit 2000A and tracking unit 3000A are used instead of focusing unit 2000 and tracking unit 3000, respectively, and step-up focusing and tracking power supplies 2300A and 3300A are used instead of the step-up/step-down type focusing and tracking power supplies 2300 and 3300 in the focusing and tracking units 2000A and 3000A. This third embodiment of the invention is therefore described referring to the step-up focusing and tracking power supplies 2300A and 3300A. More particularly, this embodiment is described with reference to the focusing unit 2000A while noting that the arrangement and operation of the tracking unit 3000A are the same as the focusing unit 2000A, and the effect of the tracking unit 3000A is therefore also the same.

The correlation between this third embodiment of the invention shown in FIG. 16 and the outline of the invention described in FIG. 25 is described below. The movable head shown in FIG. 25 corresponds to the optical pickup 1300; the actuators correspond to focus actuator 2100 and tracking actuator 3100; the drive output generator corresponds to focusing drive circuit 2200, tracking drive circuit 3200, and servo circuit 5200; and the drive output tracking signal generator corresponds to VB control generator 2220 that is part of focusing drive circuit 2200 and tracking drive circuit 3200; the fixed output generator corresponds to the fixed output (5V) power supply 1610; and the step-up control output generator corresponds to step-up focusing power supply 2300A and step-up tracking power supply 3300A.

The drive output generator constitutes both a focusing drive output generator and tracking drive output generator, and the focusing drive output generator corresponds to the focusing drive circuit 2200 and servo circuit 5200, and the tracking drive output generator corresponds to the tracking drive circuit 3200 and servo circuit 5200.

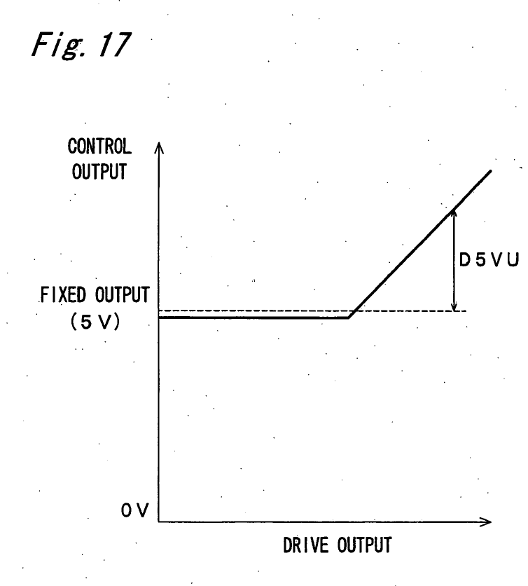

FIG. 17 shows the correlation between control output VC1 from the step-up focusing power supply 2300A, and the drive outputs VO1+ and VO1− of the focusing drive circuit 2200 in this third embodiment of the invention. Control output VC1 is shown on the y-axis, and drive outputs VO1+ and VO1− are shown on the x-axis. Both axes represent voltage, and control output VC1, drive outputs VO1+ and VO1−, and fixed output PVCC (5V) are all denoted in volts. As noted above, both axes could represent current and control output VC1, drive outputs VO1+ and VO1−, and fixed output PVCC (5V) could all be denoted as current.

As will be known from FIG. 17, if the drive output of the focusing drive circuit 2200 is greater than or equal to fixed output PVCC (5V), a control output VC1 boosted only D5VU from fixed output PVCC (5V) is supplied to the focusing drive circuit 2200, and the step-up type focusing power supply 2300A thus operates in the step-up mode. If the drive output of the focusing drive circuit 2200 is less than or equal to fixed output PVCC (5V), control output VC1 equal to fixed output PVCC (5V) is supplied to the focusing drive circuit 2200, and the step-up focusing power supply 2300A operates in a fixed output mode.

While the fixed output PVCC is supplied from a fixed output (5V) power supply 1610 with an output voltage of 5V in this example, a 3.3V power supply 1630 with an output voltage of 3.3 V can be used as the fixed output power supply to further reduce power consumption if this lower voltage power source can produce the maximum drive outputs VO1+ and VO1− required by the focusing drive circuit 2200. The fixed output power source is also not limited to 5V or 3.3V as described here, and can be any desirable voltage.

This embodiment is described above with particular reference to the focusing unit 2000A, but the arrangement, operation, and benefits afforded by the tracking unit 3000A are the same.

First Embodiment of the Step-Up Type Focusing Power Supply

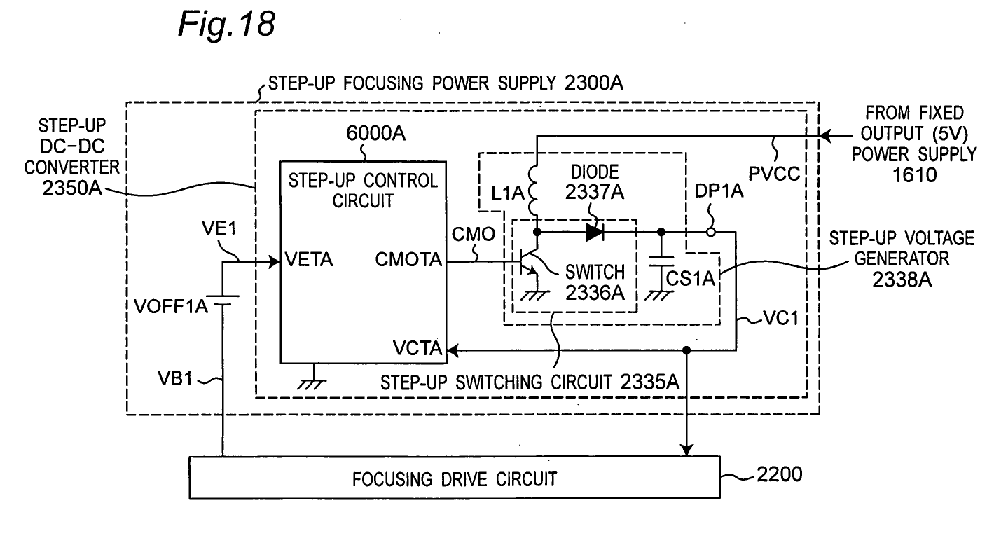

FIG. 18 is a detailed block diagram showing a first embodiment of the step-up focusing power supply 2300A in this third embodiment of the invention.

This first embodiment of the step-up focusing power supply 2300A comprises a step-up DC-DC converter 2350A, and the step-up DC-DC converter 2350A comprises a step-up control circuit 6000A and step-up voltage generator 2338A.

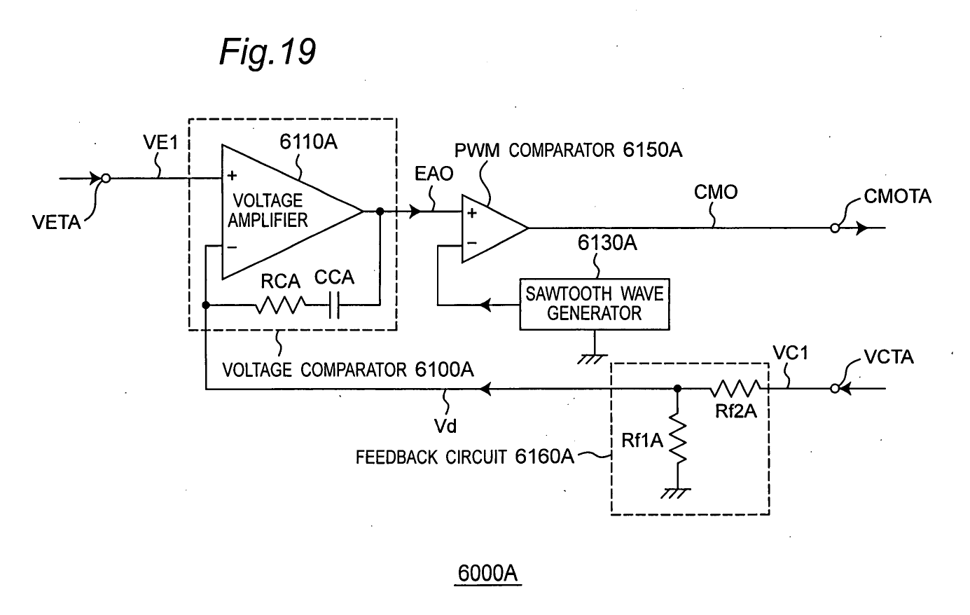

FIG. 19 is a circuit diagram of the step-up control circuit 6000A.

The step-up control circuit 6000A comprises a voltage comparator 6100A, sawtooth wave generator 6130A, and PWM comparator 6150A. The voltage comparator 6100A is composed of a voltage amplifier 6110A, resistance RCA, and capacitance CCA.

The reference voltage input terminal VETA of the step-up control circuit 6000A is connected through the input terminal of the voltage comparator 6100A to the non-inverted input terminal of the voltage amplifier 6110A. The output terminal of the voltage amplifier 6110A is connected to the output terminal of the voltage comparator 6100A and one side of capacitance CCA. The other side of capacitance CCA is connected to one side of resistance RCA, and the other side of resistance RCA is connected to the inverted input terminal of the voltage amplifier 6110A.

The output terminal of the voltage comparator 6100A is connected to the non-inverted input terminal of PWM comparator 6150A. The output terminal of the sawtooth wave generator 6130A is connected to the inverted input terminal of the PWM comparator 6150A, and the output terminal of the PWM comparator 6150A is connected to output terminal CMOTA.

Another input terminal VCTA to the step-up control circuit 6000A is the input node to feedback circuit 6160A, and the output node of the feedback circuit 6160A is connected to the inverted input terminal of voltage amplifier 6110A through another input terminal to the voltage comparator 6100A. The input node of the feedback circuit 6160A is connected to one side of resistance Rf2A. The other side of resistance Rf2A is connected to one side of resistance Rf1A and the output terminal of feedback circuit 6160A, and the other side of resistance Rf1A is to ground.

The step-up voltage generator 2338A in the step-up DC-DC converter 2350A shown in FIG. 18 comprises inductor L1A, step-up switching circuit 2335A, and capacitor CS1A.

The output terminal CMOTA of step-up control circuit 6000A is connected to the control input terminal that controls the step-up switching circuit 2335A contained in the step-up voltage generator 2338A. The step-up switching circuit 2335A is composed of an npn transistor switch 2336A and a commutation diode 2337A. The base of switch 2336A is the control input terminal noted above and is connected to output terminal CMOTA of step-up control circuit 6000A. The emitter of the switch 2336A goes to ground, and the collector is connected to one side of inductor L1A and the anode of diode 2337A. The other side of the inductor L1A is connected to the fixed output (5V) power supply 1610. The cathode of diode 2337A is connected to one side of smoothing capacitor CS1A, the other side of which goes to ground, and to the control output terminal DP1A. This control output terminal DP1A is the output terminal of step-up DC-DC converter 2350A and step-up focusing power supply 2300A, and is connected to the input terminal VCTA of step-up control circuit 6000A.

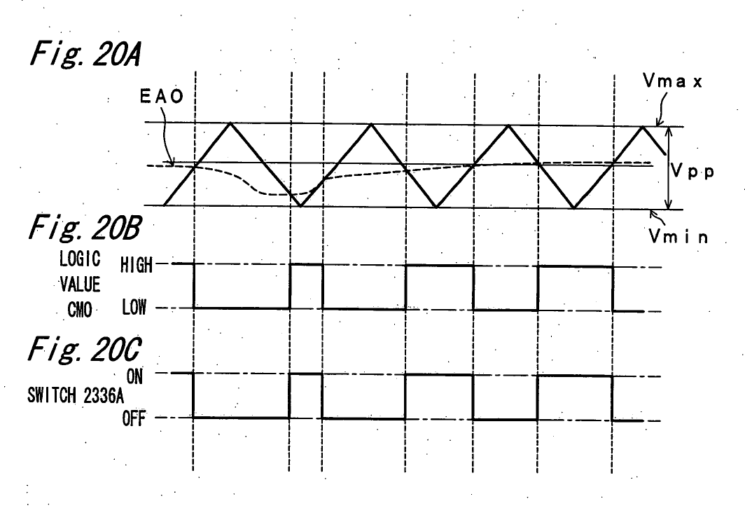

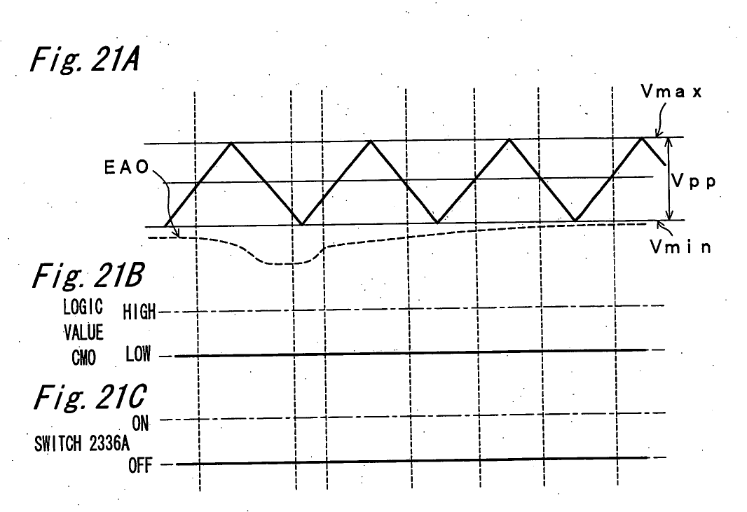

Operation of this step-up DC-DC converter 2350A is described next with reference to. FIG. 18 and FIG. 19 and the operating wave diagrams shown in FIG. 20 and FIG. 21.

The control output VC1 from control output terminal DP1A is applied through feedback circuit 6160A to the inverted input terminal of voltage comparator 6100A as feedback voltage Vd. The relationship between feedback voltage Vd and control output VC1 is defined by equation (5).
Vd=((Rf1A/(Rf1A+Rf2A))*VC1 (5)

The voltage comparator 6100A compares second reference voltage VE1 and feedback voltage Vd, and the resulting voltage difference EAO is sent to PWM comparator 6150A. Capacitance CCA and resistance RCA render a phase compensation function affording stable operation of the step-up DC-DC converter 2350A. A sawtooth wave of minimum potential Vmin, maximum potential Vmax, and amplitude Vpp(=Vmax−Vmin) is sent from sawtooth wave generator 6130A to PWM comparator 6150A.

The PWM comparator 6150A compares the sawtooth wave and voltage difference EAO, and outputs the result as logic value CMO to step-up switching circuit 2335A.

FIG. 20 shows the operating wave when Vd<=VE1. When PWM comparator 6150A determines that Vmin<EAO<Vmax, logic value CMO varies as shown in FIG. 20B.

FIG. 21 shows the operating waves when VE1<Vd. In this case PWM comparator 6150A determines that EAO<Vmin and logic value CMO is as shown in FIG. 21B.

Logic value CMO thus determines whether the step-up DC-DC converter 2350A operates in the step-up mode or fixed output mode.

When logic value CMO goes HIGH and LOW synchronized to the period of the sawtooth wave, switch 2336A repeatedly switches ON and OFF. At this time one side of the inductor L1A goes to the same potential as fixed output PVCC, and the other side switches between 0V and 5V synchronized to the period of the sawtooth wave. When the other side is 0V, the inductor L1A stores energy, and when the other side is 5V, the inductor L1A discharges the energy to capacitor CS1A. The control output VC1 is thus stepped up because the voltage equivalent of this energy is added to the 5V.

When logic value CMO is LOW, switch 2336A is OFF. More specifically, the control output VC1 goes to the voltage equal to the fixed output PVCC minus the forward voltage of the diode 2337A or the voltage drop of the serial resistance of the inductor L1A, and the step-up DC-DC converter 2350A thus operates in a fixed output mode supplying power equal to the fixed output PVCC.

FIG. 20C and FIG. 21C show the state of the switch 2336A during this operation.

The amount of the step-up is determined by the on/off duty ratio of switch 2336A, which operates at the period of the sawtooth wave based on the result from PWM comparator 6150A. The voltage boost increases as the ratio of the ON period of switch 2336A increases.

The step-up DC-DC converter 2350A thus operates in the step-up mode when Vd<=VE1 and in the fixed output mode when VE1<Vd, and thereby works to drive feedback voltage Vd equal to second reference voltage VE1. As will be known from equation (5), control output VC1 thus converges to second reference voltage VE1 to satisfy equation (6) shown below.
VC1=((Rf1A+Rf2A)/Rf1A)*VE1 (6)

The step-up DC-DC converter 2350A thus comprises a feedback circuit 6160A that generates feedback voltage Vd proportionally to control output VC1 and less than or equal to control output VC1; a voltage comparator 6100A that compares second reference voltage VE1 and feedback voltage Vd, and generates voltage difference EAO; a PWM comparator 6150A that converts voltage difference EAO to PWM signal CMO; and step-up voltage generator 2338A that switches and converts the fixed output PVCC to control output VC1 based on the PWM signal CMO.

The step-up voltage generator 2338A comprises step-up switching circuit 2335A, inductor L1A, and capacitor CS1A, and control output VC1 is output from both sides of capacitor CS1A.

In addition, the step-up DC-DC converter 2350A in the step-up type focusing power supply 2300A controls fixed output PVCC based on drive output tracking signal VB1; and produces control output VC1 corresponding to second reference voltage VE1 as a result of applying the voltage sum of drive output tracking signal VB1 and tracking signal offset voltage VOFF1A as second reference voltage VE1 to reference voltage input terminal VETA. If the drive output is greater than or equal to fixed output PVCC, control output VC1 is boosted to fixed output PVCC or greater in a step-up mode to satisfy equation (7). If the drive output is less than or equal to fixed output PVCC, control output VC1 is goes to a level equal to fixed output PVCC, and the step-up DC-DC converter 2350A operates in the fixed output mode. Generating control output VC1 according to the second reference voltage VE1 here includes both the step-up mode operation and fixed output mode operation.
VC1=((Rf1A+Rf2A)/Rf1A)*(VB1+VOFF1A) (7)

By appropriately setting tracking signal offset voltage VOFF1A, control output VC1 can also be set slightly higher than the drive output. Furthermore, if drive output tracking signal VB1 varies according to drive waveform signal VIN1, control output VC1 also varies accordingly.

The switch 2336A and diode 2337A composing the step-up switching circuit 2335A shown in FIG. 18 can be replaced by two MOS power transistors, and the two MOS power transistors can be operated using a synchronous rectifier method. In this case the step-up control circuit 6000A is arranged to control these two synchronous rectifier MOS power transistors as described above.

An n-channel MOS transistor can also be used instead for switch 2336A, thus enabling a switching operation using MOS switches.

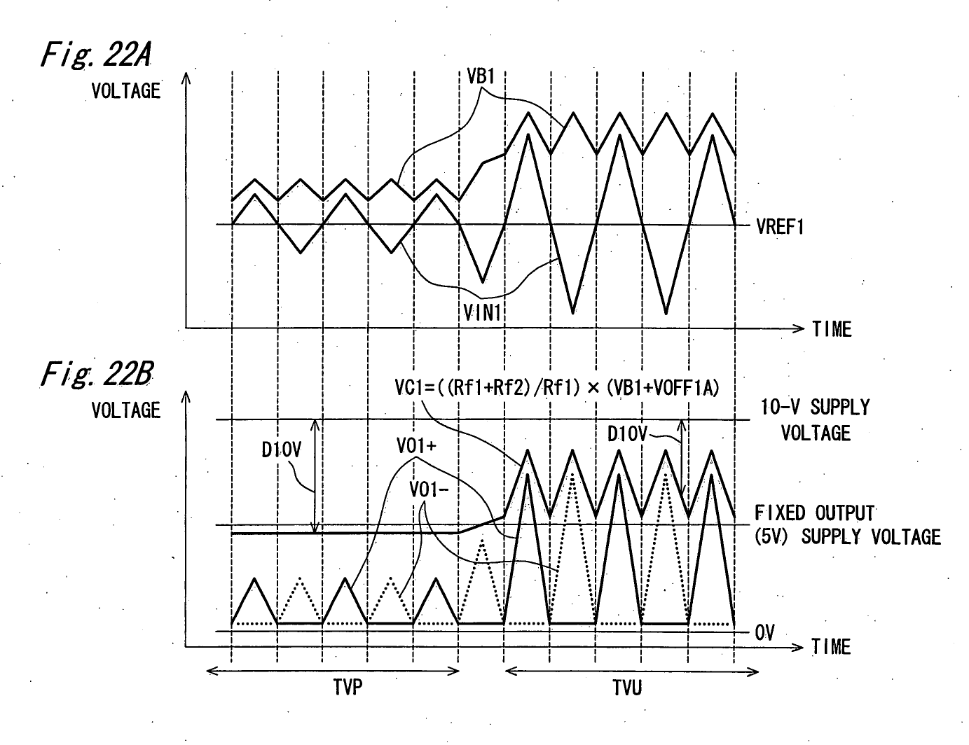

FIG. 22 is a waveform diagram showing the main signals described in FIG. 18, FIG. 16, and FIG. 3. FIG. 22A is a waveform diagram of the drive output tracking signal VB1, first reference voltage VREF1, and drive waveform signal VIN1. FIG. 22B is a waveform diagram of the control output VC1 and drive outputs VO1+ and VO1− in step-up period TVU and fixed output period TVP. Voltage is on the y-axis in FIG. 22, but the signals could be expressed as current instead.

As will be known from the arrangement described above, the drive output tracking signal VB1 shown in FIG. 22A is the absolute value of drive waveform signal VIN1 relative to the first reference voltage VREF1 plus a predetermined voltage. The second reference voltage VE1 at the reference voltage input terminal VETA of the step-up DC-DC converter 2350A is thus (VB1+VOFF1A).

As a result, the control output VC1 tracking the second reference voltage VE1 in FIG. 22B is defined by equation (7). The control output VC1 wave is therefore slightly larger than drive output VO1+ and VO1−following the peak drive outputs VO1+ and VO1−, which are output in a balanced mode by the drive output generating elements.

What the control output VC1 wave being slight larger than drive output VO1+ and VO1− means is described next. From a perspective, the control output VC1 wave is slightly higher than drive output VO1+ and VO1− and the waveforms are roughly the same near the peak of the drive output VO1+ and VO1− as shown in FIG. 22B. Thus, if the tracking signal offset voltage VOFF1A is set appropriately (to zero or any appropriate positive or negative level), the tracking signal offset voltage VOFF1A can be minimized without adversely affecting the drive output VO1+ and VO1− produced by the drive output generating element.

The control output VC1 is boosted from fixed output PVCC in the step-up period TVU, but consumes less power and produces less heat than linear drive output generating elements that simply output difference voltage D10V from a 10-V power source in an arrangement that supplies a 10-V power supply directly to the drive output generating elements. In the fixed output period TVP, control output VC1 goes to fixed output PVCC.

Linear drive type drive output generating elements are used in the third embodiment of the invention as described above. This prevents generating unnecessary high frequency noise, eliminates the need for a special electromagnetic shield that is difficult to render and requires tuning, and thus affords stable focusing and improves the playback error rate.

Furthermore, the step-up type focusing power supply 2300A enables supplying control output VC1 that is higher than fixed output PVCC. When high drive output VO1+ and VO1− is required, this improves the drive capacity of the focusing drive circuit 2200 and improves high speed servo response, thereby increasing tolerance for disc warp and eccentricity, and thus improving the usability of the drive apparatus. The ability to accommodate a heavier objective lens is also improved.

Operation with minimal power consumption is also possible and heat output from the drive output generating elements is not a problem because the drive output is produced using the minimum necessary control output VC1 tracking the drive outputs VO1+ and VO1− while also affording improved drive capacity.

Yet further, if low drive output is sufficient, control output VC1 equals fixed output PVCC, and power consumption is commensurate with fixed output PVCC.

Whether drive outputs VO1+ and VO1− are greater than or less than fixed output PVCC, control output VC1 can be set to the minimum required level following the drive outputs VO1+ and VO1− by automatically switching the step-up and fixed output operation, and the required drive output VO1+ and VO1− can be supplied to the focus actuator 2100 with minimum power consumption.

The problem of the trade-off between reducing power consumption and improving usability is thus solved.

The third embodiment above is described with particular reference to the focusing unit 2000A shown in FIG. 16, but the tracking unit 3000A features the same arrangement and operation as the focusing unit 2000A and therefore also affords the same benefits.

Arrangements having more than one focusing unit 2000A or tracking unit 3000A will also afford the same benefits as a result of having the same arrangement and operation.

### Fourth Embodiment

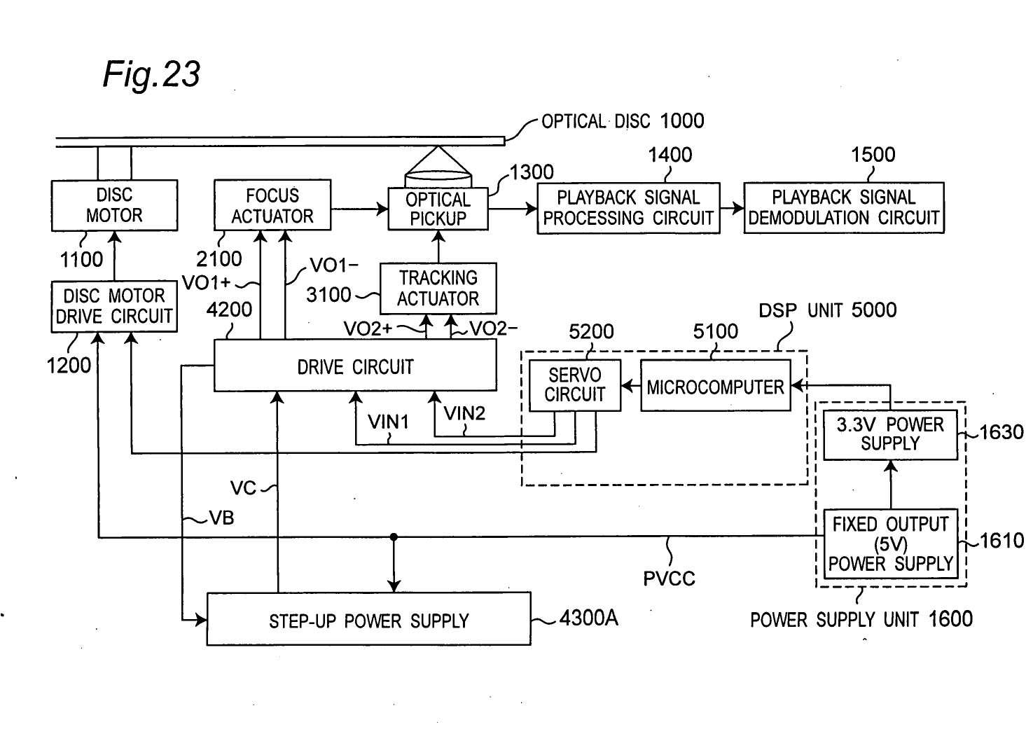

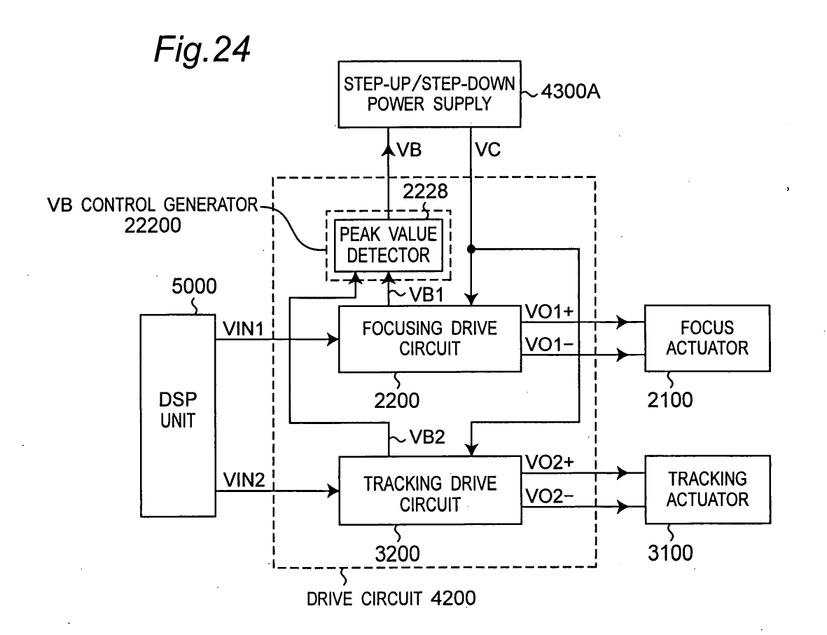

FIG. 23 is a block diagram of a drive apparatus according to a fourth embodiment of the invention. FIG. 24 is a detailed block diagram of the drive circuit 4200 in the third embodiment shown in FIG. 23. The fourth embodiment shown in FIG. 23 differs from the third embodiment shown in FIG. 16 is that the step-up type focusing power supply 2300A and step-up type tracking power supply 3300A are combined into a single step-up power supply 4300A, and the focusing drive circuit 2200 and tracking drive circuit 3200 are combined into a single drive circuit 4200.

While a step-up power supply 4300A having the same arrangement is provided separately for the focusing unit 2000A and tracking unit 3000A in the third embodiment shown in FIG. 16, the system requires only one in this fourth embodiment shown in FIG. 23. Therefore, the arrangement, operation, and effect of step-up type focusing power supply 2300A, step-up type tracking power supply 3300A, and step-up power supply 4300A are the same. The step-up power supply 4300A also contains a tracking signal offset voltage VOFFA that is identical in structure, operation, and effect as the tracking signal offset voltage VOFF1A of the step-up focusing power supply 2300A.

The drive circuit 4200 shown in FIG. 24 is basically the same as the drive circuits in the third embodiment shown in FIG. 16, and has focusing drive circuit 2200 and tracking drive circuit 3200. The focusing drive circuit 2200 and tracking drive circuit 3200 can be rendered in the same way as the first embodiment of a focusing drive circuit shown in FIG. 3, the second embodiment of a focusing drive circuit shown in FIG. 10, or the third embodiment of a focusing drive circuit as shown in FIG. 12.

Regarding the drive output tracking signal, a VB control generator 2220 is rendered in both the focusing drive circuit 2200 and tracking drive circuit 3200 in FIG. 23. These two VB control generators 2220 respectively output drive output tracking signals VB1 and VB2. The peak value detector 2228, which is a specific embodiment of VB control generator 22200, is arranged as previously described with reference to FIG. 13, and outputs the peak value of secondary drive output tracking signals VB1 and VB2, that is, the higher of the two voltages, as drive output tracking signal VB to the step-up power supply 4300A. The drive output tracking signal VB is a signal equal to the maximum value of and includes these two secondary drive output tracking signals VB1, VB2.

Furthermore, because the control output. VC of the step-up power supply 4300A is the supply voltage of the drive output generating elements contained in focusing drive circuit 2200 and tracking drive circuit 3200, power consumption and heat output by the linear drive output generating elements can be suppressed by appropriately setting the tracking signal offset voltage VOFFA (to zero or a desirable positive or negative value) while still supplying the current required to drive focus actuator 2100 and tracking actuator 3100.

In this fourth embodiment of the invention the two VB control generators 2220 in the focusing drive circuit 2200 and tracking drive circuit 3200 are referred to as “secondary drive output tracking signal generator” and the VB control generator 22200 is referred to as a “wrapping arrangement.”

The step-up power supply 4300A thus enables supplying control output VC that is higher than fixed output PVCC. When high drive output VO1+, VO1−, VO2+, VO2− is required, this improves the drive capacity of the drive circuit 4200 and improves high speed servo response, thereby increasing tolerance for disc warp and eccentricity, and thus improving the usability of the drive apparatus. The ability to accommodate a heavier objective lens is also improved.

Operation with minimal power consumption is also possible and heat output from the drive output generating elements is not a problem because the drive output is produced using the minimum necessary control output VC tracking the drive outputs VO1+, VO1−, VO2+, VO2− while also affording improved drive capacity.

Yet further, if low drive output is sufficient, control output VC is effectively equal to fixed output PVCC, and power consumption commensurate with fixed output PVCC is sufficient.

Whether drive output VO1+, VO1−, VO2+, VO2− is greater than or less than fixed output PVCC, control output VC can be set to the minimum required level following the drive output VO1+, VO1−, VO2+, VO2− by automatically switching the step-up and fixed output operation, and the required drive output VO1+, VO1−, VO2+, VO2− can be supplied to the focus and tracking actuators 2100 and 3100 with minimum power consumption.

This fourth embodiment of the invention also simplifies the construction and lowers the cost of the drive apparatus by using just one step-up/step-down power supply 4300 as the power supply generating the control output VC supplied to the focusing and tracking drive circuits 2200 and 3200.

The problem of the trade-off between reducing power consumption and improving usability is thus solved.

In the preferred embodiments of the present invention described above the control output that is a fundamental part of the present invention is slightly greater than the drive output. The optimum conditions enabling a maximum reduction in power consumption for the drive output required by the focusing and tracking actuators 2100 and 3100 is to add the loss incurred by the drive output generating elements to transient peaks in the drive output. In order to easily implement the present invention in a variety of drive apparatuses cost effectively, the power supply may have more gradual peaks and valleys than the peak waveform of the drive output. Power consumption will be somewhat greater in this case than under the ideal conditions described above, but the object of the present invention can still be sufficiently achieved.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. A drive apparatus for supplying drive output to an actuator for operating a movable head, comprising:
a fixed output generator operable to produce a predetermined fixed output;
a drive output tracking signal generator operable to detect the drive output required to drive the actuator, and to generate a drive output tracking signal that follows the drive output;
a step-up type control output generator operable to generate control output that is greater than or equal to the fixed output and slightly greater than drive output when the drive output is greater than or equal to the fixed output based on the fixed output and the drive output tracking signal; and
a drive output generator operable to produce the drive output using the control output.

2. The drive apparatus described in claim 1, wherein when the drive output is less than or equal to the fixed output, the step-up type control output generator produces control output that is less than or equal to the fixed output and slightly greater than the drive output.

3. The drive apparatus described in claim 1, wherein when the drive output is less than or equal to the fixed output, the step-up type control output generator produces control output that is effectively equal to the fixed output.

4. The drive apparatus according to claim 1, wherein:
the actuator comprises first and second input terminals;
the drive output generator comprises
a servo circuit for generating a drive waveform signal, and
a drive circuit;
wherein the drive circuit comprises a drive output generating element group for generating a pair of drive outputs with an opposite phase relationship using the control output based on the drive waveform signal; and
the pair of drive outputs is supplied to the first and second input terminals.

5. The drive apparatus according to claim 4, wherein the drive output tracking signal is based on the absolute value of the difference between the drive waveform signal and a predetermined first reference voltage.

6. The drive apparatus according to claim 1, wherein the drive output tracking signal is the greatest of a plurality of drive outputs.

7. The drive apparatus according to claim 4, wherein the pair of drive outputs are supplied to the first and second input terminals of the actuator from the emitter or source terminals of the pair of drive output generating elements; and
the drive output tracking signal is the maximum base voltage or gate voltage of the pair of drive output generating elements.

8. The drive apparatus according to claim 4, wherein the drive output generating elements are npn transistors or n-channel MOS transistors.

9. The drive apparatus according to claim 1, wherein the movable head is an optical pickup.

10. The drive apparatus according to claim 1, wherein the actuator is a focus actuator for moving the objective lens of the movable head in the focusing direction; and
the drive output generator is a focusing drive output generator operable to supply drive output to the focus actuator.

11. The drive apparatus according to claim 1, wherein the actuator is a tracking actuator for moving the objective lens of the movable head in the tracking direction; and
the drive output generator is a tracking drive output generator operable to supply drive output to the tracking actuator.

12. The drive apparatus according to claim 1, wherein there are n actuators and n drive output generators; and
the drive output tracking signal generator comprises
n secondary drive output tracking signal generator operable to detect at least the n drive outputs required to drive each of the n actuators, and to generate n secondary drive output tracking signals following the n drive outputs, and
a wrapping arrangement operable to bundle the n secondary drive output tracking signals and to generate a single drive output tracking signal.

13. The drive apparatus according to claim 1, wherein the step-up type control output generator comprises a step-up DC-DC converter for generating a supply voltage corresponding to a second reference voltage that is equal to the drive output tracking signal plus a predetermined tracking signal offset voltage; and
the step-up DC-DC converter produces control output that is greater than or equal to the fixed output and slightly greater than the drive output based on the fixed output and the second reference voltage when the drive output is greater than or equal to the fixed output.

14. The drive apparatus according to claim 13, wherein:
the step-up DC-DC converter comprises
a feedback circuit for producing a feedback voltage that is proportional to the control output and is less than or equal to the control output,
a voltage comparator for comparing the second reference voltage and the feedback voltage, and outputting the voltage difference of the second reference voltage and the feedback voltage,
a PWM comparator for converting the voltage difference to a PWM signal, and
a step-up voltage generator for switching and converting the fixed output to the control output based on the PWM signal;
the step-up voltage generator comprises a step-up switching circuit, an inductor, and a capacitor; and
the control output is output from both ends of the capacitor.

15. The drive apparatus according to claim 14, wherein the step-up switching circuit comprises:
an npn transistor having the base connected to a control terminal for controlling the step-up switching circuit, the emitter connected to ground, and the collector connected to one side of the inductor; and
a diode of which the anode is connected to the collector of the npn transistor and the cathode is connected to one side of the capacitor.

16. The drive apparatus according to claim 14, wherein the step-up switching circuit comprises:
an n-channel MOS transistor having the gate connected to a control terminal for controlling the step-up switching circuit, the source connected to ground, and the drain connected to one side of the inductor; and
a diode of which the anode is connected to the drain of the n-channel MOS transistor and the cathode is connected to one side of the capacitor.

17. The drive apparatus according to claim 14, wherein the step-up switching circuit comprises two MOS power transistors in a synchronous rectifier arrangement.

18. The drive apparatus according to claim 2, wherein:
the step-up control output generator comprises a step-up/step-down DC-DC converter for generating a supply voltage corresponding to a second reference voltage that is equal to the drive output tracking signal plus a predetermined tracking signal offset voltage; and
the step-up/step-down DC-DC converter produces a control output that is greater than or equal to the fixed output and slightly greater than the drive output based on the fixed output and the second reference voltage when the drive output is greater than or equal to the fixed output, and produces a control output that is less than or equal to the fixed output and slightly greater than the drive output when the drive output is less than or equal to the fixed output.

19. The drive apparatus according to claim 18, wherein:
the step-up/step-down DC-DC converter comprises
a feedback circuit for producing a feedback voltage that is proportional to the control output and is less than or equal to the control output,
a voltage comparator for comparing the second reference voltage and the feedback voltage, and outputting the voltage difference of the second reference voltage and the feedback voltage,
a plurality of PWM comparators for converting the voltage difference to a PWM signal, and
a step-up/step-down voltage generator for switching and converting the fixed output to the control output based on the plural PWM signals;
the step-up/step-down voltage generator comprises a step-up switching circuit, a step-down switching circuit, an inductor, and a capacitor; and
the control output is output from both ends of the capacitor.

20. The drive apparatus according to claim 19, wherein:
the step-up switching circuit comprises
an npn transistor having the base connected to a control terminal for controlling the step-up switching circuit, the emitter connected to ground, and the collector connected to one side of the inductor; and
a diode of which the anode is connected to the collector of the npn transistor and the cathode is connected to one side of the capacitor; and
the step-down switching circuit comprises
a pnp transistor having the base connected to a control terminal for controlling the step-down switching circuit, the emitter connected to the fixed output generator, and the collector connected to the other side of the inductor; and
a diode of which the anode is to ground and the cathode is connected to the collector of the pnp transistor.

21. The drive apparatus according to claim 19, wherein:
the step-up switching circuit comprises
an n-channel MOS transistor having the gate connected to a control terminal for controlling the step-up switching circuit, the source connected to ground, and the drain connected to one side of the inductor; and
a diode of which the anode is connected to the drain of the n-channel MOS transistor and the cathode is connected to one side of the capacitor; and
the step-down switching circuit comprises
a p-channel MOS transistor having the gate connected to a control terminal for controlling the step-down switching circuit, the source connected to the fixed output generator, and the drain connected to the other side of the inductor; and
a diode of which the anode is to ground and the cathode is connected to the collector of the p-channel MOS transistor.

22. The drive apparatus according to claim 19, wherein the step-up switching circuit and step-down switching circuit each comprise two MOS power transistors in a synchronous rectifier arrangement.

23. The drive apparatus according to claim 3, wherein:
the step-up control output generator comprises a step-up/fixed DC-DC converter for generating a supply voltage corresponding to a second reference voltage that is equal to the drive output tracking signal plus a predetermined tracking signal offset voltage; and
the step-up/fixed DC-DC converter produces a control output that is greater than or equal to the fixed output and slightly greater than the drive output based on the fixed output and the second reference voltage when the drive output is greater than or equal to the fixed output, and produces a control output that is effectively equal to the fixed output when the drive output is less than or equal to the fixed output.

24. The drive apparatus according to claim 23, wherein:
the step-up/fixed DC-DC converter comprises
a feedback circuit for producing a feedback voltage that is proportional to the control output and is less than or equal to the control output,
a voltage comparator for comparing the second reference voltage and the feedback voltage, and outputting the voltage difference of the second reference voltage and the feedback voltage,
a PWM comparator for converting the voltage difference to a PWM signal, and
a step-up voltage generator for switching and converting the fixed output to the control output based on the PWM signal;
the step-up voltage generator comprises a step-up switching circuit, an inductor, and a capacitor; and
the control output is output from both ends of the capacitor.

25. The drive apparatus according to claim 24, wherein the step-up switching circuit comprises:
an npn transistor having the base connected to a control terminal for controlling the step-up switching circuit, the emitter connected to ground, and the collector connected to one side of the inductor; and
a diode of which the anode is connected to the collector of the npn transistor and the cathode is connected to one side of the capacitor.

26. The drive apparatus according to claim 24, wherein the step-up switching circuit comprises:
an n-channel MOS transistor having the gate connected to a control terminal for controlling the step-up switching circuit, the source connected to ground, and the drain connected to one side of the inductor; and
a diode of which the anode is connected to the drain of the n-channel MOS transistor and the cathode is connected to one side of the capacitor.

27. The drive apparatus according to claim 24, wherein the step-up switching circuit comprises two MOS power transistors in a synchronous rectifier arrangement.

28. A method for supplying drive output to an actuator for operating a movable head, comprising:
a step of producing a predetermined fixed output;
a step of detecting the drive output required to drive the actuator, and generating a drive output tracking signal that follows the drive output;
a step of generating control output that is greater than or equal to the fixed output and slightly greater than drive output when the drive output is greater than or equal to the fixed output based on the fixed output and the drive output tracking signal; and
a step of producing the drive output using the control output.
